(19) United States
(12) Patent Application Publication
(10) Pub. No.: US 2026/0277578 A1
(43) Pub. Date: Sep. 17, 2026

(54) DEPLOYING AUTONOMOUS SOFTWARE AGENTS VIA THIRD-PARTY MESSAGING APPLICATIONS

(71) Applicant: COGNITION AI, INC., San Francisco, CA (US)

(72) Inventors: Tony Jiang, Sunnyvale, CA (US); Scott Wu, Atherton, CA (US); Steven Hao, Atherton, CA (US); Sampriti Panda, Menlo Park, CA (US); Walden Yan, Atherton, CA (US); Adhyyan Sekhsaria, San Francisco, CA (US); Jeffrey Ling, Redwood City, CA (US); Moritz Stephan, San Francisco, CA (US)

(21) Appl. No.: 19/561,179

(22) Filed: Mar. 9, 2026

Related U.S. Application Data
(60) Provisional application No. 63/770,816, filed on Mar. 12, 2025.

(51) Int. Cl. G06F 8/61

(52) U.S. Cl. CPC G06F 8/61

(57) ABSTRACT

The present disclosure relates to systems, methods, and non-transitory computer-readable media that connects with a messaging application for digital conversations between a plurality of users and deploys an autonomous software agent via a prompt received from the messaging application. In particular, the disclosed systems connect a messaging application with an autonomous software agent system. Moreover, the disclosed systems receive a prompt to activate an autonomous software agent from the messaging application. Additionally, the disclosed systems deploy the autonomous software agent that operates within an independent virtual machine computing environment to generate artificial intelligence outputs responsive to the prompt and proves the artificial intelligence outputs to the messaging application.

### CROSS REFERENCE TO RELATED APPLICATIONS

This application claims the benefit of and priority to U.S. Provisional Application No. 63/770,816, filed Mar. 12, 2025. The aforementioned application is hereby incorporated by reference in its entirety.

### BACKGROUND

Advancements in computing devices and networking technology have given rise to a variety of innovations in machine learning and digital co-pilot assistants. Over time, computing systems have been developed that generate computer code to assist (e.g., in a co-pilot like manner) a software developer in completing their computer tasks. For instance, some existing systems can assist software developers in generating code by supplementing computer code or making tweaks to existing computer code. Despite these advances, however, existing systems continue to suffer from a number of disadvantages, particularly in terms of computational efficiency, technical accuracy, and operational flexibility.

### SUMMARY

One or more embodiments described herein provide benefits and/or solve one or more problems in the art with systems, methods, and non-transitory computer-readable media that deploy an autonomous software agent and execute software tasks based on receiving a prompt to activate the autonomous software agent from a messaging application between a plurality of users. To illustrate, in one or more embodiments, the disclosed systems connect a messaging application for digital conversations between a plurality of users with an autonomous software agent system. Moreover, in one or more embodiments, the disclosed systems receive a prompt (e.g., from a third-party messaging application) to activate an autonomous software agent and as part of the request, receive a software task. Specifically, in response to the request, the disclosed systems deploy an autonomous software agent to perform the software task (e.g., generate computer code, create an application end-to-end, fine-tune an artificial intelligence model, debug computer code, etc.).

In one or more embodiments, the disclosed systems execute the software task and generate one or more artificial intelligence outputs responsive to the prompt. In some embodiments, the disclosed systems provide the one or more artificial intelligence outputs to the messaging application between the plurality of users.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of an autonomous software agent system deploying an autonomous software agent in response to receiving a prompt via a messaging application between a plurality of users in accordance with one or more implementations;

FIG. 2 illustrates an example diagram of the autonomous software agent system utilizing an autonomous software agent to generate artificial intelligence outputs and providing the outputs to a messaging application between a plurality of users in accordance with one or more implementations;

FIG. 3 illustrates an example diagram of the autonomous software agent system utilizing an autonomous software agent to access a plurality of software composition tools in accordance with one or more implementations;

FIGS. 4A-4D illustrate example graphical user interfaces of the autonomous software agent system connecting with a messaging application and receiving prompts in accordance with one or more implementations;

FIGS. 5A-5I illustrate example graphical user interfaces of the autonomous software agent system executing a software task and providing outputs to a messaging application between a plurality of users in accordance with one or more implementations;

FIGS. 6A-6L illustrate example graphical user interfaces of the autonomous software agent system executing an iterative software task based on communications received via a messaging application between a plurality of users;

FIG. 7 illustrates an example diagram of an architectural layer design of the autonomous software agent system which accesses various artificial intelligence models to enable an independent virtual machine computing environment of an autonomous software agent in accordance with one or more implementations;

FIG. 8 illustrates an example diagram of a virtual private cloud housing an independent virtual machine computing environment that is in communication with an autonomous agent model backend in accordance with one or more implementations;

FIG. 9 illustrates an example diagram of a frontend layer interacting with an autonomous software agent system ingestion layer and a virtual private cloud in accordance with one or more implementations;

FIG. 10 illustrates an example environment of the autonomous software agent system in accordance with one or more implementations;

FIG. 11 illustrates an example series of acts for deploying an autonomous software agent and providing artificial intelligence outputs to a third-party messaging application in accordance with one or more implementations;

FIG. 12 illustrates an example series of acts for deploying an autonomous software agent and providing progress status updates to a third-party messaging application in accordance with one or more implementations; and

FIG. 13 illustrates a block diagram of an exemplary computing device in accordance with one or more implementations.

### DETAILED DESCRIPTION

One or more embodiments described herein include an autonomous software agent system that receives a prompt from a messaging application between a plurality of users (e.g., a third-party messaging application) and deploys an autonomous software agent based on the prompt. To illustrate, in one or more embodiments, an autonomous software agent system 100 connects with a third-party messaging application and receives a prompt to kick off non-trivial software tasks, such as fixing computer bugs, feature requests, and multi-order requests. In some embodiments, the autonomous software agent system 100 responds in-thread with updates and questions within the third-party messaging application between a plurality of users.

In one or more embodiments, the autonomous software agent system 100 receives a tag/mention within the third-party messaging application and transmits the tag/mention to a server that hosts an autonomous software agent of the autonomous software agent system 100. In particular, the autonomous software agent system 100 receives the prompt from the third-party messaging application and deploys an autonomous software agent to independently complete software development tasks such as writing computer code tests, adding features to an existing code repository, adding functionality to an existing codebase, developing prototypes, and building integrations between software applications.

In one or more embodiments, the autonomous software agent system 100 utilizes the autonomous software agent to execute a plurality of sub-tasks from the prompt received from the third-party messaging application. Additionally, in some embodiments, the autonomous software agent system 100 can provide at least one of progress status updates or artificial intelligence outputs to the third-party messaging application. In one or more embodiments, the autonomous software agent system 100 can receive additional instructions/guidance from any user part of the third-party messaging application (e.g., connected with the autonomous software agent system 100) to push the direction/progress of a software task into a different direction. In doing so, the autonomous software agent system 100 improves the technical accuracy and computational efficiency of collaborative and non-trivial software tasks between a plurality of different software developers.

In one or more embodiments, the autonomous software agent system 100 transmits incremental updates to the third-party messaging application during execution of a software task. For example, an initial acknowledgment message may be posted within a conversation thread, and subsequent updates may modify the previously posted message to reflect progress, status changes, or completion results. In some embodiments, private or ephemeral messages may be transmitted to a specific user for confirmation, approval, or notification without persisting in a shared conversation history.

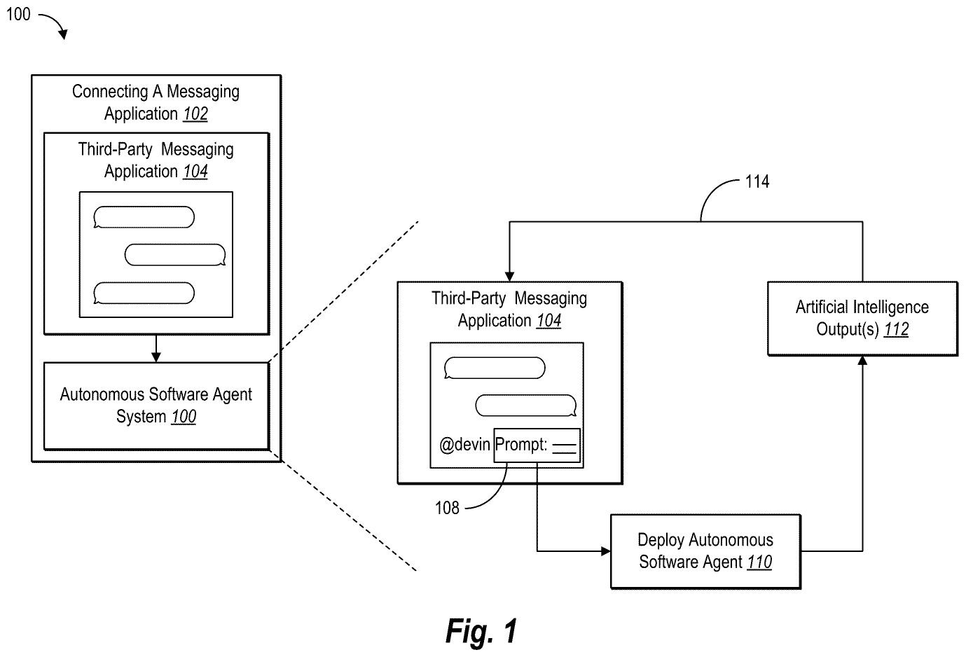

FIG. 1 illustrates an overview diagram of the autonomous software agent system 100 connecting with a third-party messaging application and providing artificial intelligence outputs to the third-party messaging application in accordance with one or more embodiments. For example, FIG. 1 shows the autonomous software agent system 100 performing an act 102 of connecting a third-party messaging application 104 (e.g., between a plurality of users) with the autonomous software agent system 100.

In one or more embodiments, the act 102 of connecting the third-party messaging application 104 with the autonomous software agent system 100 refers to an integration with an external application. For example, the connection can refer to an API integration, a webhook integration, or a software development kit for the autonomous software agent system 100 to connect with the third-party messaging application 104. To illustrate, the autonomous software agent system 100 can utilize an application programming interface to send and fetch messages from the third-party messaging application 104.

Further, the autonomous software agent system 100 can utilize a webhook to listen to triggers from the third-party messaging application 104. In particular, the autonomous software agent system 100 can expose an endpoint, and the third-party messaging application 104 calls the endpoint in response to a triggering event (e.g., a tag or mention of the autonomous software agent system 100).

In one or more embodiments, upon receiving an event payload from the third-party messaging application 104, the autonomous software agent system 100 verifies authenticity of the event prior to processing. For example, the third-party messaging application 104 may include a digital signature generated using a signing secret and a timestamp value. The autonomous software agent system 100 may compute a hash-based message authentication code (HMAC) over the request payload and compare the computed signature to the received signature. Additionally, the autonomous software agent system 100 may validate freshness of the timestamp to mitigate replay attacks. Events that fail signature validation or freshness thresholds may be rejected without further processing.

In one or more embodiments, the autonomous software agent system 100 maintains a persistent bidirectional communication channel with the third-party messaging application 104 using a WebSocket-based or similar persistent connection. For example, instead of receiving events via a publicly accessible HTTP endpoint, the autonomous software agent system 100 may establish a socket connection authenticated via an application-level token, through which the third-party messaging application 104 pushes event payloads. This configuration may be used in restricted network environments or enterprise deployments where inbound webhook exposure is undesirable.

In one or more embodiments, the connection requires authentication and authorization. In particular, the connection utilizes API keys, OAuth (tokens that expire and refresh), and signed requests. Furthermore, the autonomous software agent system 100 performs the act 102 of connecting with the third-party messaging application 104, which includes a data mapping and normalization process. In particular, the autonomous software agent system 100 maps chats/messaging within a thread from the third-party messaging application 104 to conversational parameters understandable by the autonomous software agent system 100 (e.g., understanding when to deploy an autonomous software agent and which tools to provide based on messages received from the third-party messaging application 104).

In one or more embodiments, the autonomous software agent system 100 preprocesses message content received from the third-party messaging application prior to task planning. For example, the autonomous software agent system 100 removes or normalizes mention prefixes, formatting markup, and channel metadata. The autonomous software agent system 100 may extract hyperlinks referencing external repositories or issue trackers and transform them to structured metadata. The autonomous software agent system 100 can provide the resulting normalized content to a planner tool for use in generating an artificial intelligence plan.

In one or more embodiments, integration between the autonomous software agent system 100 and a third-party messaging application 104 is established via an authorization flow. For example, upon installation of an application associated with the autonomous software agent system 100 within a messaging workspace, the third-party messaging application 104 may provide one or more authorization credentials, including an access token, an application-level token, and a workspace identifier. The autonomous software agent system 100 securely stores such credentials in association with a tenant record corresponding to the messaging workspace. In some embodiments, credentials are encrypted at rest and logically isolated per workspace to prevent cross-tenant access. The autonomous software agent system 100 may further associate the messaging workspace identifier with a corresponding organization account, repository configuration, or virtual private cloud (VPC) instance, thereby mapping messaging-originated events to a tenant-specific execution environment.

In one or more embodiments, a prompt refers to a natural language prompt (from a user computing device), an application programming interface call, and/or a tag/mention in the third-party messaging application 104 received by the autonomous software agent system 100. In one or more embodiments, the prompt refers to a request, a question, or an instruction submitted by a user of a user account corresponding to a computing device (e.g., a user computing device). In particular, the prompt can include text instructions and/or image data received from a user computing device. As shown in FIG. 1, the autonomous software agent system 100 receives a prompt 108 from the third-party messaging application 104.

In one or more embodiments, a messaging application (e.g., the third-party messaging application 104) refers to a software platform that enables a plurality of users (e.g., human users) and/or computer systems to exchange messages in real-time or near real-time within organized conversations or conversation threads. In other words, the messaging application refers to a software platform that lets a plurality of users send, receive, and manage text, media, and communication within chats, channels or threads, often with features for collaboration, notifications, and integration with other tools. In particular, a messaging application includes a variety of message-based communications, such as text messages, emojis, and reactions.

Additionally, a messaging application can also support images, files, voice notes, and/or videos (e.g., the autonomous software agent system 100 can receive file uploads from a user computing device to execute a software task according to the file uploads). Additionally, a messaging application includes persistent messages, where a user can scroll within a messaging application interface and search for previously exchanged messages. As shown in FIG. 1, the autonomous software agent system 100 connects with the third-party messaging application 104. In this context, the term third-party messaging application refers to a software platform outside of the autonomous software agent system 100 that integrates with the autonomous software agent system 100.

FIG. 1 shows the autonomous software agent system 100 receiving the prompt 108 to deploy an autonomous software agent, and the autonomous software agent system 100 performs an act 110 of deploying the autonomous software agent. In one or more embodiments, the autonomous software agent system 100 deploys the autonomous software agent (e.g., a cloned virtual machine that is isolated and can perform tasks siloed from other virtual machine computing devices). In particular, the autonomous software agent system 100 deploys the autonomous software agent within an independent virtual machine computing environment and generates and runs code in its own isolated environment.

In one or more embodiments, the independent virtual machine computing environment refers to a software-based simulation that independently runs its own operating system and applications as a standalone machine. For example, a virtual machine computing environment 204 refers to a software-implemented computational environment that emulates a physical computing system and provides an isolated, executable runtime environment for code generation, execution, testing, modification, or orchestration by the autonomous software agent system 100. In one or more embodiments, the virtual machine computing environment may operate as a system-level virtualization layer (e.g., hypervisor-based virtual machine), an operating system-level container, a language runtime virtual machine, or a custom execution sandbox, and may be dynamically provisioned, configured, and decommissioned under control of the virtual machine computing environment. Thus, a deployed autonomous software agent independently leverages its own independent computing environment.

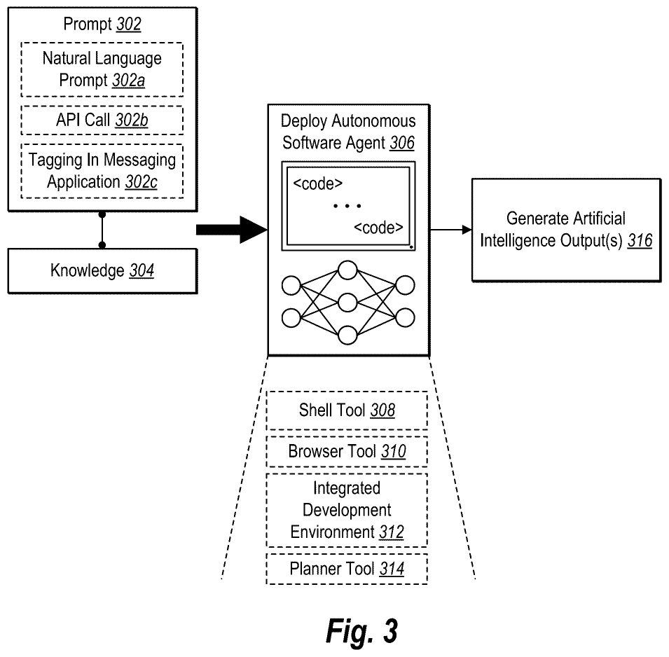

In other words, the autonomous software agent exists independently of a computing device of a user who submitted a prompt to deploy the autonomous software agent and performs tasks based on knowledge that is provided to it. Moreover, the autonomous software agent system 100 further provides to the autonomous software agent computer software composition tools. Details pertaining to the computer software composition tools are given in more detail below in the description of FIG. 3.

In one or more embodiments, the autonomous software agent system 100 provides the autonomous software agent with its own software development environment (e.g., the independent virtual machine computing environment with access to the computer software composition tools) to perform individualized tasks and not merely supplementary tasks (e.g., the autonomous software agent can deploy its own codebase by replicating an existing codebase, make changes to an existing codebase, implement changes to a codebase, and run tests for computer code generated by an autonomous software agent).

In some embodiments, the autonomous software agent includes a set of artificial intelligence models. In particular, the autonomous software agent includes one or more machine learning models, neural networks, large language models, chain-of-thought reasoning models, and/or vision-language models. Thus, the autonomous software agent system 100 deploys an autonomous software agent that operates within an independent virtual machine computing device with various machine learning components used to analyze, process, and generate information.

In one or more embodiments, a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, a multi-layer perceptron, a large language model (LLM), a generative pre-trained transformer model (GPT), a chain-of-thought machine learning model, etc. In some embodiments, a neural network includes a combination of neural networks or neural network components.

In one or more embodiments, a language model includes a set of statistical or probabilistic functions to perform Natural Language Processing (NLP) in order to understand, learn, and/or generate human natural language content. For example, the autonomous software agent system 100 uses a language model as a tool that determines the probability of a given sequence of words occurring in a sentence or natural language sequence. Simply put, the autonomous software agent system 100 uses a model that is trained to predict the next word in a sentence.

A language model is called a large language model (LLM) when it is trained on an enormous amount of data (e.g., a threshold amount of data) and/or has a large number of parameters. These models have capabilities ranging from writing a simple essay to generating complex computer codes—all with limited to no supervision. Accordingly, an LLM can comprise a deep neural network that is very large (billions to hundreds of billions of parameters) and understands, processes, and produces human natural language by being trained on massive amounts of text.

These models predict future words in a sentence letting them generate sentences similar to how humans talk and write or otherwise in a form dictated, for instance, by a prompt. In one or more implementations, an LLM utilized by the autonomous software agent system 100 employs a “chain-of-thought” reasoning approach that allows the model to internally deliberate before providing responses. Indeed, one or more implementations include a LLM trained using reinforcement learning techniques that enable the LLM to refine its reasoning skills through iterative feedback.

Additionally, FIG. 1 shows the autonomous software agent system 100 generating artificial intelligence output(s) 112. For example, the autonomous software agent system 100 deploys the autonomous software agent to execute a software task indicated by the prompt 108 and generates the artificial intelligence output(s) 112 for one or more tasks of the software task. Examples of the artificial intelligence output(s) 112 are provided in more detail below in the description of FIG. 3. Additionally, FIG. 1 shows the autonomous software agent system 100 performing an act 114 of providing the artificial intelligence output(s) 112 to the third-party messaging application 104.

As mentioned above, existing systems are inefficient. For example, existing systems provide code generation assistant features to assist a developer in completing their software tasks. However, these existing systems merely supplement developer work. In particular, existing systems require heavily involved guidance, prompting, monitoring, and the use of a developer's device in order to supplement developer work. In other words, existing systems merely act as a co-pilot to a developer. Accordingly, existing systems suffer from computational inefficiencies of attempting to integrate a code development assistant into a developer's workflow and often suffer from being prompted and re-prompted to yield satisfactory results (e.g., which results in wasted computational resources).

In addition to their inefficiency issues, existing systems are also inaccurate. More particularly, due to the standard paradigm of existing systems supplementing code development, existing systems are often incomplete or inadequate in generating complex and extensive computer code. Moreover, existing systems often supplement code development efforts but generate computer code that inaccurately addresses an intent (expressed by an input prompt) and/or that is operationally invalid, including syntactic errors, semantic errors, and/or logical errors.

In particular, existing systems may be able to generate computer code to supplement a developer's task, however it is often difficult or impossible to follow/understand the thought process of existing code generation systems writing computer code. Often, existing code generation systems are a black box that receive instructions and output computer code (e.g., which results in difficulties understanding how the existing code generation system arrived at its answer). As such, modifying intermediate steps of a (supplementary) software coding task performed by existing code generation systems are often infeasible.

Relatedly, existing systems suffer from operational inflexibility. Because existing systems are limited to supplementing code development for cases expressly coded by engineers, these existing systems fail to adapt to creating new computer code, tackling complex non-trivial tasks, correctly understanding already generated computer code and/or effectively performing tests on computer code. Indeed, the inflexible nature of existing systems severely hampers the ability of existing systems to keep up with the taxing demands of software development from a holistic perspective. In other words, existing systems are stuck operating as a co-pilot developer to merely supplement a software developer's workflow.

In one or more embodiments, the autonomous software agent system 100 provides several improvements over conventional systems in relation to technical accuracy, computational efficiency, and operational flexibility. In contrast to existing systems, which require heavily involved guidance, prompting, monitoring, and the use of a developer's device (in order to supplement developer work), the autonomous software agent system 100 deploys an autonomous software agent that operates as an independent virtual machine computing device.

In doing so, the autonomous software agent system 100 allows for an autonomous software agent to operate independently to solve non-trivial tasks, and it does not conflate or confuse the context of other ongoing tasks. Specifically, the autonomous software agent system 100 silos/isolates autonomous software agents (e.g., to operate independently with fully featured computer software composition tools discussed in more detail in FIG. 3) such that the autonomous software agents can accurately perform their assigned software tasks without being bogged down by additional information.

In one or more embodiments, the autonomous software agent system 100 further improves upon technical inaccuracies by connecting/integrating with a third-party messaging application. In some embodiments, the autonomous software agent system 100 receives one or more messages (e.g., prompts) from the third-party messaging application and kicks off a development session using an autonomous software agent. In particular, the autonomous software agent system 100 can receive the context of a conversation thread, messages from one or more users within the conversation thread, and construct/plan a non-trivial software task that is responsive to the one or more messages received from the third-party messaging application.

In one or more embodiments, the autonomous software agent system 100 improves upon technical inaccuracies by providing to the messaging application, artificial intelligence outputs (e.g., generated by an autonomous software agent executing a software task) and/or progress status updates corresponding to artificial intelligence outputs. In doing so, the autonomous software agent system 100 provides opportunities for software developers to intervene, provide additional context, provide additional guidance, provide files, and/or provide images to guide the direction of a software task. Accordingly, the autonomous software agent system 100 enhances the collaborative and complex workflow of software developers that leverage an autonomous software agent operating within an independent virtual machine computing environment.

In one or more embodiments, the autonomous software agent system 100 further improves upon technical inaccuracies. In contrast to existing systems, which are often incomplete or inadequate in generating complex and extensive computer code, the autonomous software agent system 100 deploys an autonomous software agent that uses an intelligent orchestration process to determine how to understand a relevant code repository/environment, how to generate artificial intelligence outputs (e.g., computer code) that match a determined context, and how to choose between various artificial intelligence models to accomplish various software tasks.

In some embodiments, the autonomous software agent system 100 allows a user of a computing device to configure an autonomous software agent environment and deploys the autonomous software agent to complete a software task, thus improving the technical accuracy of artificial intelligence agents performing software tasks (e.g., relative to existing systems). Additionally, as mentioned above, the autonomous software agent system 100 also allows users to provide additional configuration tips/context from a third-party messaging application as one or more tasks of a software task are being executed by the autonomous software agent.

In one or more embodiments, the autonomous software agent system 100 enables a user computing device to follow the work of an autonomous software agent as it performs a software coding task within a web browser application of the autonomous software agent system 100. For example, the autonomous software agent system 100 displays commands submitted by the autonomous software agent via a terminal, computer code being written by the autonomous software agent via an editor, and computer code being debugged by the autonomous software agent. As such, the autonomous software agent system 100 enables a user of a computing device to more accurately understand the manner in which an autonomous software agent arrived at a final result (e.g., the user computing device can follow the autonomous software agent in real-time).

Additionally, the autonomous software agent system 100 can transmit communications between a web browser application of the autonomous software agent system 100 and the third-party messaging application to keep users of the third-party messaging application up-to-date and apprised of any instructions/commands given through the web browser application. Accordingly, the autonomous software agent system 100 orchestrates instructions coming from both the web browser application of the autonomous software agent system 100 and the third-party messaging application to more accurately accomplish a software task.

Relatedly, the autonomous software agent system 100 also improves computational efficiency of software tasks by enabling options for a user of a computing device to follow an autonomous software agent executing a software task. In particular, as mentioned, the autonomous software agent can operate independently, and in some instances, a user can intervene or understand the steps/thought processes of an autonomous software agent by following the autonomous software agent as it switches between using different computer software composition tools.

In particular, a user of a computing device can follow an autonomous software agent as it switches between different computer software composition tools to execute a software task. In doing so, the autonomous software agent system 100 saves computational resources and time as a user can more efficiently understand the process of an autonomous software agent (e.g., as it performs a task or after it performs a task) and the user can intervene at one or more points in the development session to aid/assist an autonomous software agent.

As mentioned above, the autonomous software agent system 100 also allows users to follow an autonomous software agent executing a software task via an integration with a third-party messaging application. In particular, as mentioned, the autonomous software agent system 100 transmits progress status updates and/or artificial intelligence outputs from an autonomous software agent executing a software task to the third-party messaging application. Additionally, in some embodiments, the autonomous software agent system 100 alters the behavior of the autonomous software agent based on inputs received from the third-party messaging application.

Furthermore, the autonomous software agent system 100 improves computational efficiency by enabling a user computing device to continue to delegate entire non-trivial software coding tasks to the autonomous software agent (e.g., via the third-party messaging application) while the autonomous software agent is already working completely asynchronously. As the autonomous software agent is executing a software coding task, a user can delegate (e.g., via the third-party messaging application) multiple additional autonomous software agents to perform additional software tasks. Thus, the autonomous software agent system 100 enables large scale parallelization of tasks.

In one or more embodiments, the autonomous software agent system 100 further improves upon operational inflexibilities. In contrast to existing systems, which are rigidly tied to code supplementation, the autonomous software agent system 100 deploys an autonomous software agent that operates within an independent virtual machine computing environment and further allows a user to monitor/modify the progress of the autonomous software agent (if so desired). Moreover, because the autonomous software agent system 100 deploys an autonomous software agent that is provided with various development box tools, the autonomous software agent acts as an advanced reasoning tool to complete non-trivial tasks. Accordingly, the autonomous software agent system 100 enhances the flexibility of operations in performing code generation tasks relative to existing systems.

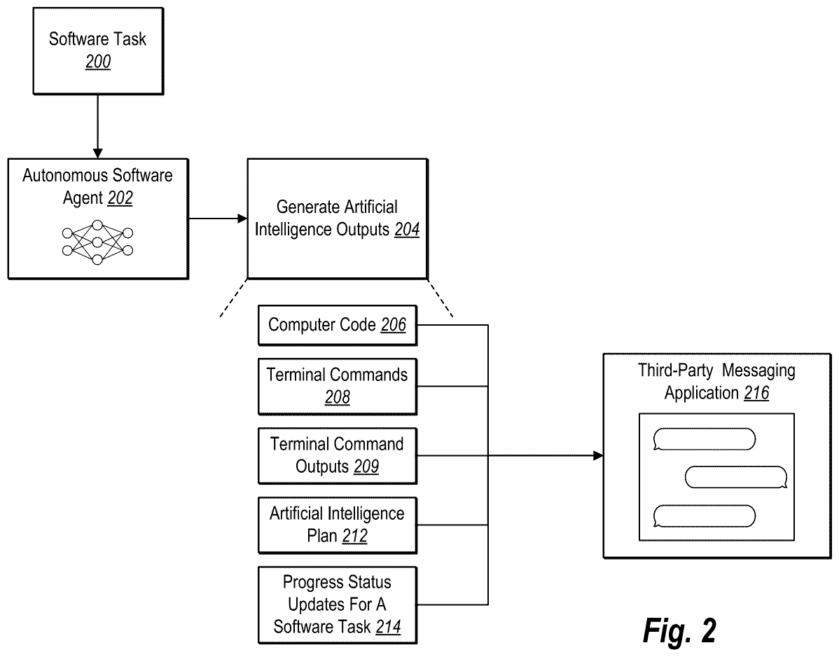

FIG. 2 illustrates the autonomous software agent system 100 generating artificial intelligence outputs in accordance with one or more embodiments. For example, FIG. 2 shows the autonomous software agent system 100 receiving/accessing a software task 200 and deploying an autonomous software agent 202 to execute the software task 200.

In one or more embodiments, the software task 200 refers to a defined unit of work in a software project to be planned, assigned, executed and/or completed. For example, the software task 200 refers to a specific software component for the autonomous software agent system 100 to build, change, fix, and/or maintain based on requirements of a prompt/request. In other words, the software task 200 refers to a discrete, actionable piece of work that contributes to the development, maintenance, or improvement of a software system. More specifically, a software task refers to a defined computational objective, instruction set, or problem specification that can be satisfied through the generation, modification, execution, analysis, or orchestration of computer-executable code by an artificial intelligence (AI) code-writing agent.

A software task may be expressed in natural language, structured prompts, formal specifications, source code fragments, test cases, API definitions, configuration files, user stories, or any combination thereof. In one or more embodiments, a software task defines one or more functional, logical, structural, or performance requirements that constrain or guide code generation or transformation. For example, a software task may include, without limitation: generating source code implementing specified functionality; translating code between programming languages or frameworks; completing partial code segments; refactoring, optimizing, or modifying existing code; debugging code based on error messages, stack traces, or failing tests; generating unit tests, integration tests, or documentation; constructing data pipelines, scripts, or infrastructure definitions; performing static or dynamic analysis and producing corrective modifications; or orchestrating multi-step development workflows involving code synthesis and validation.

In one or more embodiments, a software task may further include associated constraints such as target programming language, runtime environment, library dependencies, security policies, performance thresholds, coding standards, or interface requirements. In some embodiments, a software task may be decomposed into subtasks, iteratively refined, validated against automated test harnesses, or dynamically modified based on intermediate execution results. The autonomous software agent system 100 may autonomously interpret, prioritize, sequence, and execute one or more software tasks within a broader development objective. Unless expressly limited, a software task encompasses any machine-interpretable or human-specified objective that can be fulfilled, in whole or in part, through automated code generation or code manipulation.

FIG. 2 shows the autonomous software agent system 100 generating artificial intelligence outputs 204. As shown in FIG. 2, the autonomous software agent system 100 generates the artificial intelligence outputs that include at least one of computer code 206, terminal commands 208, terminal command outputs 209, an artificial intelligence plan 212, and progress status updates 214 for the software task 200. In some embodiments, the computer code 206 includes a set of instructions written in a programming language that a computing device can interpret and execute to perform a specific task. In particular, the computer code 206 includes a series of statements and functions that execute specific operations. Further, the computer code 206 includes statements written in specific syntax and translatable into machine code to be executed by a computing device.

Further, the computer code 206 can include function code and test code. In some embodiments, function code refers to a set of instructions written in a programming language that a computing device can interpret and execute to perform a specific task. Function code can include a series of statements and functions that define specific operations or processes performed by a computer upon execution of the code. In some cases, function code includes statements written in specific syntax and translatable into machine code to be executed by a computing device for performing one or more processes of an overall intent.

In some embodiments, test code refers to computer code that defines a function test for function code. For example, test code can include one or more code segments for determining that the function code satisfies an intent query. In some cases, the autonomous software agent system 100 utilizes test code to test function code. For example, the autonomous software agent system 100 generates the test code that includes computer code for testing whether the output of function code satisfies an intent query. In some embodiments, test code can also test for different types of errors (e.g., syntax errors and logic errors) and/or for hazardous or harmful function code.

In some embodiments, the computer code 206 includes executable program code which refers to a set of instructions that a computing device can directly execute. In particular, executable program code includes machine-readable instructions that result from compiling high-level programming languages. In other words, executable program code refers to a final output for a software development process created by compiling source code.

In one or more embodiments, the autonomous software agent system 100 generates the computer code 206 from executing the software task 200 and provides the computer code 206 to a third-party messaging application 216. In particular, the autonomous software agent system 100 provides the computer code 206, and in some embodiments, receives one or more inputs from users of the third-party messaging application 216 to revise the computer code 206. Accordingly, the autonomous software agent system 100 can iteratively execute the software task 200 based on inputs received via the third-party messaging application 216.

In one or more embodiments, a terminal command refers to text instructions to instruct a computer's operating system. In particular, a terminal command refers to one-line instructions that typically call upon existing programs of an operating system. In some embodiments, a terminal command refers to text-based instructions submitted/inputted into a terminal (e.g., the terminal is an interface that allows computing devices such as the autonomous software agent 202 to interact with a computer system's underlying operating system or run scripts and programs directly). To illustrate, the terminal commands 208 can include file and directory navigation, file operations, viewing file contents, searching and filtering, processes and systems in an operating system, determining permissions and ownerships in an operating system, and networking.

In one or more embodiments, the terminal command outputs 209 refer to outputs that correspond with the terminal commands 208. To illustrate, a terminal command output can include an absolute path (e.g., in response to a command to determine a location), tabular text (e.g., in response to a command to list files), raw file text (e.g., in response to a command to print file contents), an interactive viewer (e.g., in response to a command to provide a paged output), an output pattern (e.g., in response to a command to search/filter files in an operating system), and a file path (e.g., in response to a command to locate files).

Likewise, the autonomous software agent system 100 can provide the terminal commands 208 and/or the terminal command outputs 209 to the third-party messaging application 216. In particular, the autonomous software agent system 100 can receive one or more inputs from the third-party messaging application 216 and re-submit terminal commands modified according to the one or more inputs. In other words, the autonomous software agent system 100 iteratively executes the software task 200 according to inputs received from the third-party messaging application 216 (e.g., in response to providing the terminal commands 208 and/or the terminal command outputs 209).

In one or more embodiments, the artificial intelligence plan 212 refers to a plan generated by an artificial intelligence model that analyzes the software task 200. For example, the artificial intelligence plan 212 refers to a structured and hierarchical plan that breaks down/decomposes a prompt/request indicating the software task 200 into a plurality of tasks/sub-tasks. Accordingly, the autonomous software agent system 100 generates the artificial intelligence plan 212 and provides it to the third-party messaging application 216.

Similarly, the autonomous software agent system 100 provides the artificial intelligence plan 212 to the third-party messaging application 216. In doing so, the autonomous software agent system 100 can receive user inputs to the artificial intelligence plan 212 from users of the third-party messaging application 216. Accordingly, the autonomous software agent system 100 can receive feedback/input from users of the third-party messaging application 216 and generate an updated/modified artificial intelligence plan.

In one or more embodiments, the autonomous software agent system 100 analyzes conversation thread messages within the third-party messaging application to identify recurring guidance or policy statements provided by users. Upon detecting repeated instructions or structured guidance, the autonomous software agent system 100 may generate a knowledge suggestion and transmit a confirmation request within the messaging interface. Upon approval, the guidance may be stored as a knowledge item associated with the messaging workspace, repository, or organization scope for reuse in subsequent development sessions.

In one or more embodiments, the progress status updates 214 refer to a progress/direction of a sub-task of the software task 200. In particular, the autonomous software agent system 100 can generate the progress status updates 214 as in progress, queued, completed, and failed. Additionally, the autonomous software agent system 100 can provide the progress status updates 214 to the third-party messaging application 216. In some embodiments, the autonomous software agent system 100 receives user inputs regarding the progress status updates 214 which can alter the course of the autonomous software agent executing the software task 200. To illustrate, the autonomous software agent system 100 can receive a user input to stop performing a first sub-task and to proceed with a second sub-task based on the progress status updates 214 provided to the third-party messaging application 216.

FIG. 3 illustrates an overview of the autonomous software agent system 100 generating artificial intelligence outputs by deploying an autonomous software agent in accordance with one or more embodiments. For example, FIG. 3 shows the autonomous software agent system 100 accessing/receiving a prompt 302. In particular, the prompt 302 refers to a natural language prompt 302a (from a user computing device), an application programming interface call 302b, and/or a tag/mention 302c in a messaging application.

In some embodiments, via an API, a user computing device can build custom workflows using an API of the autonomous software agent system 100 and programmatically assign tasks for the autonomous software agent system 100 to perform. Further, with the API, users of computing devices can essentially plug in the autonomous software agent system 100 into any of their software development and internal tools.

In some embodiments, the autonomous software agent system 100 deploys an autonomous software agent in response to being triggered by a code editor. In particular, from another code editor/integrated development environment (IDE), users of computing devices who use visual studio code (or visual studio code forks) can assign tasks to the autonomous software agent system 100 directly from their code editor/IDE.

As mentioned, in some embodiments, the autonomous software agent system 100 can deploy an autonomous software agent in response to being tagged/mentioned in a third-party messaging application. In particular, user computing devices can tag the autonomous software agent system 100 directly from conversations they are having with colleagues in the messaging application. Furthermore, the autonomous software agent system 100 will reply directly in the messaging thread and anyone can jump into the thread and provide further instructions to the autonomous software agent system 100.

In one or more embodiments, the autonomous software agent system 100 may be invoked via structured commands, interactive message shortcuts, or structured command payloads provided by the third-party messaging application. For example, a command invocation may transmit a command string and contextual metadata to the autonomous software agent system 100, which may initiate or modify a development session accordingly. Contextual menu actions may similarly transmit structured payloads that identify a target message, file, or thread, enabling the autonomous software agent system 100 to extract relevant context for processing.

In some embodiments, the autonomous software agent system 100 integrated with a messaging application further includes a centralized server. In particular, the autonomous software agent system 100 utilizes a centralized server that is responsible for forwarding information between the autonomous software agent system 100 and the messaging application. To illustrate, a user computing device can install a messaging integration for the autonomous software agent system 100 into a messaging workspace and further add the integration to the relevant channels of a messaging application.

In some embodiments, if the autonomous software agent system 100 receives a tag/mention of an autonomous software agent in the messaging application, then the autonomous software agent system 100 utilizes a centralized server to recognize the tag/mention. Furthermore, the autonomous software agent system 100 passes that tag/mention along to a web server backend that a website hosted by the autonomous software agent system 100 uses to start a new session (e.g., initiate an autonomous software agent for deployment).

In one or more embodiments, the autonomous software agent system 100 maps a messaging thread identifier to a persistent autonomous software agent session identifier. For example, a message timestamp or thread identifier corresponding to a conversation thread may be stored in association with a development session record. Subsequent messages within the same thread may be routed to the corresponding session. In some embodiments, messaging event identifiers are stored and compared to previously processed identifiers to prevent duplicate session creation or repeated execution resulting from retransmitted events.

Furthermore, the autonomous software agent system 100 can reply directly in a messaging thread of the third-party messaging application and any user part of the third-party messaging application can jump into the conversation thread and provide further instructions to the autonomous software agent system 100. Moreover, the autonomous software agent system 100 can react to messages with emojis, text, multimedia, or any other response form that a user of the third-party messaging application may employ.

In one or more embodiments, messages generated by the autonomous software agent system 100 include interactive user interface elements supported by the third-party messaging application, such as buttons, selection menus, or approval controls. For example, a generated plan may be presented with selectable options enabling a user to approve, modify, or cancel execution. Interaction events associated with such controls may be transmitted back to the autonomous software agent system 100 and processed as session modification instructions.

Further, in some embodiments, the autonomous software agent system 100 synchronizes a conversation that happens in a third-party messaging application with what happens in a web application of the autonomous software agent system 100. In particular, if someone talks to the autonomous software agent system 100 in the third-party messaging application, then that person is also talking to the autonomous software agent system 100 in the web application. Moreover, the autonomous software agent system 100 causes messages received via the web application of the autonomous software agent system 100 to be provided to the third-party messaging application.

Additionally, in some embodiments, the autonomous software agent system 100 sends messages to one or more users. In particular, when the autonomous software agent system 100 wants to send a message, the autonomous software agent system 100 stores the message in a database and simultaneously, the web server of the autonomous software agent system 100 detects the presence of the stored message.

Further, the autonomous software agent system 100 causes the web server to provide the message from the autonomous software agent system 100 within the web application (retrieves the messages). In some embodiments, the server for the third-party messaging application detects the message and forwards the message using an application programming interface of the messaging application (e.g., using the relevant conversation).

In one or more embodiments, the autonomous software agent system 100 monitors application programming interface response headers or status codes to detect rate limiting conditions imposed by the third-party messaging application. If a rate limit threshold is reached, the autonomous software agent system 100 may implement an exponential backoff strategy or queue outgoing messages for deferred transmission. Additionally, outbound requests may be retried using idempotent identifiers to ensure that duplicate messages are not posted within conversation threads.

In some embodiments, in response to reactions to messages in the third-party messaging application, the responses are extracted and forwarded to the autonomous software agent system 100. Furthermore, the autonomous software agent system 100 preserves messages even if server devices are stalled/goes down. In particular, the autonomous software agent system 100 stores messages in a database and flags messages as either processed or not processed.

In some embodiments, the autonomous software agent system 100 intakes thread context in a third-party messaging application and sends the whole contents of the conversation for downstream processing using an artificial intelligence model. In particular, the autonomous software agent system 100 processes the entire contents of a messaging thread to determine a context, background, and understanding of the entire thread, for example, utilizing a machine learning model such as a large language model. In doing so, the autonomous software agent system 100 can more accurately execute a software task indicated within the prompt 302.

As further shown in FIG. 3 and as discussed above, the autonomous software agent system 100 further accesses/receives knowledge 304. In particular, the knowledge 304 can include a development environment, guidelines, code repositories, and/or one or more software tasks. In some embodiments, the knowledge 304 refers to a form of “information” (e.g., knowledge inputs) that allows the autonomous software agent system 100 to retrieve information based on specific triggers that might be relevant to a session of the autonomous software agent. In some embodiments, the knowledge 304 can include a development environment, guidelines, code repositories, and a software task.

As further shown in FIG. 3, the autonomous software agent system 100 further performs an act of deploying an autonomous software agent 306 (e.g., a cloned virtual machine that is isolated and can perform tasks siloed from other devices). Moreover, as shown in FIG. 3, the autonomous software agent system 100 further provides to the autonomous software agent 306 a shell tool 308 (or simply shell), a browser tool 310, an integrated development environment 312 (e.g., an editor), and a planner tool 314.

For example, a shell tool 308 refers to an interface layer that mediates interaction between an artificial intelligence (AI) agent and an underlying execution environment, computing system, development environment, or virtualized runtime. The shell tool 308 provides a structured command, control, and input/output framework through which the autonomous software agent system 100 issues instructions, receives responses, and orchestrates software development operations. A shell tool 308 may comprise a command-line interpreter, application programming interface (API) interface, remote procedure call (RPC) interface, messaging interface, terminal emulator, container interface, virtual machine interface, or any combination thereof. The shell tool 308 abstracts underlying system resources-including file systems, process control, compilers, interpreters, debuggers, network interfaces, and package managers- and presents a controllable operational surface to the autonomous software agent system 100.

As used herein, a browser tool 310 (or simply browser) refers to a software component executing within an independent virtual machine computing environment and configured to retrieve, render, interpret, and interact with network-accessible resources on behalf of an autonomous software agent system 100. A browser tool 310 operates as a controlled network interaction interface within the independent virtual machine computing environment and provides the autonomous software agent system 100 with programmatic access to web content, application interfaces, documentation repositories, APIs, development resources, and other remote computing services. A browser tool 310 may implement one or more communication protocols, including HTTP, HTTPS, WebSocket, or other network transport protocols.

In the context of the autonomous software agent system 100, a browser tool 310 may be configured to retrieve web pages, API responses, source code repositories, software documentation, or structured data from remote systems; render and parse markup languages including HTML, XML, Markdown, and script-generated content; execute client-side scripts in a sandboxed runtime; extract structured representations of document object models (DOMs), metadata, form fields, and interactive elements; submit forms, authenticate sessions, manage cookies or tokens, and maintain session state; download, upload, or modify remote resources under controlled permissions; provide machine-readable representations of rendered content to the autonomous software agent system 100 for reasoning and code generation; and enforce network policies, domain restrictions, rate limits, and security guardrails.

In some embodiments, a browser tool 310 is configured to expose structured outputs such as DOM trees, accessibility trees, rendered text, event traces, console logs, or network traces—rather than or in addition to graphical output. A browser tool 310 may operate in headless mode and may be programmatically controlled via an automation interface.

A browser tool 310, as part of the independent virtual machine computing environment 304, is isolated from a host computing system and subject to resource constraints, execution monitoring, and security policies defined by the independent virtual machine computing environment 304. This isolation permits the autonomous software agent system 100 to perform research, dependency resolution, API inspection, automated testing of web applications, or code retrieval without exposing the host environment to uncontrolled network interactions. Unless expressly limited, a browser tool 310 encompasses any web client, headless browsing engine, embedded rendering engine, automated browsing framework, or network-interaction module configured to retrieve and interact with remote content within a virtualized execution environment controlled by the autonomous software agent system 100.

In one or more embodiments, the autonomous software agent system 100 utilizes the planner tool 314 to generate an artificial intelligence plan in accordance with one or more embodiments. In particular, the autonomous software agent system 100 accesses/receives the prompt 302 (e.g., from a user computing device). Furthermore, the autonomous software agent system 100 deploys the autonomous software agent 306 to operate within an independent virtual machine computing environment.

As mentioned, the autonomous software agent system 100 utilizes the planner tool 314 to improve the efficiency and accuracy of executing a software task from the prompt 302. In some embodiments, the autonomous software agent system 100 utilizes the planner tool 314 to generate a running “to do” list. In particular, the autonomous software agent system 100 can use the planner tool 314 to break down the prompt 302 and to infer one or more intents of the prompt 302. In one or more embodiments, the autonomous software agent system 100 utilizes the planner tool 314 to assist a user in visualizing how the autonomous software agent 306 (e.g., deployed by the autonomous software agent system 100) plans and thinks through solving a problem (e.g., as indicated in the prompt 302).

More specifically, that planner tool is configured to analyze one or more input objectives, user intents, or software task specifications and to generate structured, multi-step plans that guide operation of an autonomous software agent system 100 in performing code generation, modification, testing, analysis, or orchestration tasks. The planner tool 314 may be implemented using one or more underlying computational models, including but not limited to large language models (LLMs), transformer-based neural networks, sequence-to-sequence models, reinforcement learning models, probabilistic graphical models, symbolic reasoning engines, constraint solvers, heuristic search algorithms, or hybrid neuro-symbolic architectures. In one or more embodiments, planner tool 314 leverages a generative pretrained transformer model, including a code-capable language model, to infer task structure, identify implicit constraints, and predict ordered action sequences based on prior training across natural language corpora, source code repositories, execution traces, and software development workflows.

In one or more embodiments, the planner tool 314 is configured to decompose complex objectives into a sequence of actionable subtasks, determine dependencies and ordering among subtasks, and construct an execution plan consumable by downstream components such as code generation modules, debugging modules, the browser tool 310, the shell tool 308, IDE 312, testing frameworks, or other tool interfaces. The generated plan may comprise, without limitation, a hierarchical task tree, directed acyclic graph (DAG), ordered action list, state machine representation, or other structured plan representation including defined inputs, outputs, preconditions, postconditions, and success criteria.

In certain embodiments, planner tool 314 employs prompt-based reasoning, chain-of-thought inference, tree search, beam search, Monte Carlo sampling, reinforcement learning-based policy selection, or combinations thereof to evaluate multiple candidate plans and select or refine a plan according to defined optimization metrics. The planner tool 314 may further incorporate knowledge mechanisms, including contextual embeddings, vector databases, episodic execution logs, or persistent state representations, to inform plan generation based on prior interactions or historical outcomes. The planner tool 314 may monitor intermediate execution results and dynamically revise, re-order, expand, or prune subtasks based on feedback including compiler diagnostics, runtime errors, test failures, environmental changes, or external tool responses. In this manner, planner tool 314 supports iterative, adaptive, reactive, or predictive planning strategies. In some embodiments, the planner tool 314 operates as a distinct module that communicates with other components of autonomous software agent system 100 via structured messages, application programming interfaces (APIs), or message-passing protocols.

In some embodiments, the autonomous software agent system 100 utilizes a large language model (e.g., a planning model) to analyze the prompt. In one or more embodiments, the autonomous software agent system 100 utilizes the large language model that leverages retrieval-augmented generation (RAG) to generate an artificial intelligence plan. In some embodiments, retrieval-augmented generation refers to retrieving relevant information from an external database or knowledge source in the context of the prompt 302. In particular, the autonomous software agent system 100 can utilize RAG (e.g., which includes using the large language model) to generate a response (e.g., the artificial intelligence plan) by leveraging both the retrieved information (from an external source) and its own internal knowledge base. In particular, the autonomous software agent system 100 leverages RAG, which includes an input query, information retrieval, and response generation to perform a task of generating the artificial intelligence plan.

In some embodiments, the autonomous software agent system 100 further utilizes the large language model to perform an act of extracting a meta-task from the prompt 302. Moreover, as shown, the autonomous software agent system 100 performs an act of extracting intermediate tasks (e.g., sub-tasks) from the meta-task. In one or more embodiments, the autonomous software agent system 100 analyzes the prompt 302, determines an intent (e.g., a meta-task) of the prompt 302, and determines discrete sub-tasks (e.g., intermediate tasks).

In particular, the autonomous software agent system 100 can prompt the large language model to divide the prompt 302 into manageable and discrete sub-portions. In other words, the autonomous software agent system 100 prompts the large language model to identify tasks that point to different code repositories, data sources, and systems as being their own sub-task. In particular, the autonomous software agent system 100 can prompt the large language model and include example breakdowns of example requests.

Moreover, in some embodiments, the autonomous software agent system 100 trains the large language model with example datasets for breaking down a request into a meta-task and a plurality of sub-tasks. In particular, the autonomous software agent system 100 trains the large language model by having it generate a predicted artificial intelligence plan and then comparing the prediction to a ground truth reference.

In some embodiments, the autonomous software agent system 100 utilizes the large language model to generate an artificial intelligence plan to execute a software task. In particular, the autonomous software agent system 100 generates the artificial intelligence plan which includes a meta-task extracted from the prompt 302 and intermediate tasks extracted from the meta-task. In one or more embodiments, the autonomous software agent system 100 provides the artificial intelligence plan to a graphical user interface of a computing device. In particular, the autonomous software agent system 100 provides the artificial intelligence plan to receive approval or modification from a user computing device.

In some embodiments, the autonomous software agent system 100 can receive modifications to one or more tasks/sub-tasks and/or the meta-task extracted from the prompt 302. In some instances, the autonomous software agent system 100 can receive additional context or additional files (e.g., via the third-party messaging application as discussed above) to further customize the artificial intelligence plan. In some embodiments, the autonomous software agent system 100 receives one or more modifications to the artificial intelligence plan and generates a modified artificial intelligence plan.

Further, the autonomous software agent system 100 can prompt a user of a computing device (e.g., via a web browser application or the third-party messaging application) to provide approval of the modified artificial intelligence plan. In response to receiving approval of an (updated) artificial intelligence plan, the autonomous software agent system 100 deploys the autonomous software agent 306 to execute the prompt 302 according to the artificial intelligence plan.

In one or more embodiments, the autonomous software agent system 100 generates the artificial intelligence plan and generates a first progress status update corresponding to the autonomous software agent 306 utilizing the planner tool 314 to decompose the prompt 302. Furthermore, the autonomous software agent system 100 can provide the first progress status update to the third-party messaging application. In other words, the autonomous software agent system 100 can generate progress status updates corresponding to actions being performed by an autonomous software agent, such as a process of generating the artificial intelligence plan.

In some embodiments, the autonomous software agent system 100 utilizes the browser tool 310 to perform one or more actions responsive to prompt 302 to execute a software task. For example, the autonomous software agent system 100 accesses/receives the prompt 302. In one or more embodiments, the autonomous software agent system 100 utilizes the browser tool 310 to browse documentation on one or more website pages, test web applications (e.g., local applications), download information, upload information, etc. In particular, the autonomous software agent system 100 utilizes the browser tool 310 to perform a first navigation step, a second navigation step, and a third navigation step on a website domain page.

In one or more embodiments, a website page (e.g., a website domain page) refers to a webpage hosted under a domain name that serves as an entry point of a website and is identified by a URL. For example, a website page refers to a digital webpage associated with a domain name that has a unique URL and contains structured content (e.g., text, images, links, and other media). In particular, a website page is part of a larger website hierarchy. To illustrate, a website hierarchy includes a homepage, subpages, and subdomain pages. In some embodiments, a plurality of website domain pages is associated with an entity.

In one or more embodiments, the autonomous software agent system 100 utilizes the browser tool 310 to obtain information from a website page. In some embodiments, the autonomous software agent system 100 determines whether a particular portion of a website page is relevant to the prompt 302 to execute a software task. In particular, the autonomous software agent system 100 utilizes a large language model (e.g., a website relevance model) to determine the relevance of a sub-portion, portion, or an entire website page.

In other words, website pages contain an excessive amount of information. In particular, large language models are typically bogged down with processing all elements within a website page. Thus, the autonomous software agent system 100 distills a website page structure (e.g., utilizing the large language model) and provides a simplified structure (e.g., HTML) to the autonomous software agent 306 for further processing. In doing so, the autonomous software agent system 100 enables the autonomous software agent 306 to process a large amount of data from website pages without performance degradation.

In some embodiments, the autonomous software agent system 100 utilizes the large language model to perform an act of determining a document object model (DOM) of a website page. In particular, the autonomous software agent system 100 passes a website page to the large language model to determine a document object model of the website page.

In one or more embodiments, a document object model refers to a structured, hierarchical representation of a webpage's content that defines how HTML elements are programmatically accessed, modified, and analyzed. In one or more embodiments, the autonomous software agent system 100 detects a document object model object within a website page. For example, the DOM includes a representation of structure, content and properties within a website page. For instance, a user of a website page interacts with and manipulates a DOM object. Further, in some embodiments the DOM includes HTML or XML format. Accordingly, the DOM includes references to specific elements or nodes within the website domain page. To illustrate, DOM objects are part of a DOM tree structure, where each node of the DOM tree structure corresponds to a specific element in a website page.

In some embodiments, the autonomous software agent system 100 utilizes the large language model to perform an act of identifying relevant document object model elements (e.g., DOM elements). In particular, the autonomous software agent system 100 prompts the large language model to identify relevant DOM elements in the context of the prompt 302. In other words, the autonomous software agent system 100 utilizes the large language model to distill a website page into a relevant set of elements for the prompt 302.

In some embodiments, the autonomous software agent system 100 utilizes the large language model to generate a simplified DOM tree (e.g., a simplified document object model tree). As mentioned above, in some instances, a website page contains a large amount of data that can potentially bog down computational processes. As such, the autonomous software agent system 100 utilizes the large language model to extract the most salient/relevant elements from a website page (e.g., being browsed via the browser tool 310) and generates the simplified DOM tree.

In one or more embodiments, the simplified DOM tree refers to a distilled document object model structure and/or a distilled hierarchical representation of a webpage's content. In particular, the simplified DOM tree includes a hierarchy of nodes and elements from the website page that are relevant to the prompt 302. In other words, the simplified DOM tree contains fewer website page elements relative to an initially determined DOM tree from the website page.

In one or more embodiments, the autonomous software agent system 100 can utilize the simplified DOM tree as contextual data of a website domain page and determine whether to provide a progress status update or an artificial intelligence output (e.g., corresponding with the simplified DOM tree) to a third-party messaging application.

In some embodiments, the autonomous software agent system 100 utilizes the shell tool 308 to generate one or more terminal commands. In one or more embodiments, the shell tool 308 refers to one or more terminals (e.g., one or more terminal windows). In particular, the autonomous software agent system 100 deploys the autonomous software agent 306 that can create new terminal windows or switch to different terminal windows, or delete terminals (e.g., which is how an autonomous software agent can run multiple processes at once). For relatively long commands, the autonomous software agent system 100 can use the autonomous software agent 306 to shift its attention away from the long-running command and multitask in parallel (e.g., via the shell tool 308).

In some embodiments, the shell tool 308 is a text-based application where the autonomous software agent 306 can input commands that interact directly with a computer's operating system. In particular, the autonomous software agent system 100 spins up the autonomous software agent 306 that includes a shell application and in the shell application there are different terminals. As mentioned, where each terminal is like a single terminal window, the autonomous software agent system 100 (e.g., via the autonomous software agent) has the ability to create new terminals, switch to different terminal windows or delete terminals. Furthermore, the autonomous software agent system 100 performs an act of utilizing the autonomous software agent 306 to generate terminal commands. Moreover, the autonomous software agent system 100 generates command outputs.

Accordingly, the autonomous software agent system 100 utilizes the autonomous software agent 306 to execute a software task (e.g., indicated by the prompt 302) by using the shell tool 308. In particular, the autonomous software agent system 100 determines a plurality of sub-tasks for a meta-task indicated in the prompt 302, generates an artificial intelligence plan, and utilizes the shell tool to execute one or more of the sub-tasks (e.g., by submitting terminal commands).

In some embodiments, the autonomous software agent system 100 receives a selection of a shell feature and opens/launches an interactive shell of the autonomous software agent. In particular, the autonomous software agent system 100 causes a graphical user interface (e.g., of a user computing device) to show shell activity (e.g., terminal commands or outputs corresponding to terminal commands) of the autonomous software agent 306 utilizing the shell tool 308 while independently performing the software task. Accordingly, the user computing device (e.g., via the graphical user interface) can intervene (e.g., take over) the autonomous software agent's shell and push a software task in a different direction.

In some embodiments, the autonomous software agent system 100 can generate another progress status update corresponding to the autonomous software agent 306 utilizing the shell tool 308 to submit a terminal command. Furthermore, the autonomous software agent system 100 can provide an output corresponding to the terminal command to a conversation thread of the third-party messaging application.

Moreover, the autonomous software agent system 100 provides the integrated development environment 312 (IDE tool) to the autonomous software agent. In one or more embodiments, the integrated development environment 312 of the autonomous software agent 306 includes an editor (e.g., in some embodiments, the autonomous software agent 306 utilizes multiple editor tabs which represent open files in an editor area of the IDE for writing/editing computer code). In particular, the editor corresponds to an open file.

As mentioned above, the autonomous software agent 306 has access to its own editor. In some embodiments, an editor refers to a software program or tool for writing or modifying computer code. In particular, an editor streamlines a computer code writing process by providing syntax highlighting, auto-completion, and error detection. For example, the editor provides color-coding for keywords, variables, functions, and other code elements. Further, for auto-completion, the editor suggests completions for variables, methods, classes, and functions.

In some embodiments, project files refer to a set of files and resources organized together to represent a specific software coding task (e.g., project). For example, the project files can include source code (e.g., program code written in a specific programming language), configurations (e.g., settings defining how a project is built, compiled, and executed), dependencies (e.g., external libraries), libraries, assets, and other components required to complete a software coding task. In some embodiments, the autonomous software agent system 100 utilizes the integrated development environment 312 to perform an act of generating computer code.

In some embodiments, the integrated development environment (IDE) 312 refers to an editor tool to write computer code and computer tests. In some embodiments, the integrated development environment 312 is a software application that brings together software tools for software development. In particular, the integrated development environment 3212 refers to a software application that combines essential software development features (e.g., coding, debugging, testing, and deployment) to increase the efficiency of completing software projects. The IDE 312 may further maintain structured representations of a project state, including file hierarchies, dependency graphs, abstract syntax trees (ASTs), symbol tables, error diagnostics, execution traces, and build artifacts. In the context of the autonomous software agent system 100, the IDE 312 is configured to one or more software tasks; create, edit, refactor, or delete source files; invoke compilation or interpretation processes; execute unit tests or integration tests; surface compiler diagnostics and runtime errors; perform automated refactoring or formatting; manage branches and commits within a version control system; and return structured, machine-readable feedback to the autonomous software agent system 100 to enable iterative reasoning and code refinement.

As noted above, in one or more embodiments, the autonomous software agent system 100 provides actions performed by the autonomous software agent 306 to a graphical user interface of a user (e.g., a user computing device). In particular, in the context of the integrated development environment 312, the autonomous software agent system 100 can provide to a graphical user interface, real-time actions and/or actions performed during a development session of the autonomous software agent 306 utilizing the integrated development environment 312. As discussed above, in some embodiments, the autonomous software agent system 100 provides actions performed by the autonomous software agent 306 to a third-party messaging application.

In some embodiments, the autonomous software agent system 100 can generate another progress status update corresponding to the autonomous software agent 306 utilizing the integrated development environment 312 to write computer code. Furthermore, the autonomous software agent system 100 can provide an output corresponding to the computer code to a conversation thread of the third-party messaging application.

In some embodiments, the autonomous software agent system 100 can receive an input selection that relates to a user computing device indicating a desire to modify one or more inputs in the integrated development environment 312. Further, in some embodiments, the autonomous software agent system 100 can receive an input selection to follow the autonomous software agent 306 (e.g., in real-time) as the autonomous software agent 306 executes a software task indicated by the prompt 302.

In some embodiments, the autonomous software agent system 100 provides for display the integrated development environment 312 that includes the above-mentioned editor tab. Further, in some instances, the autonomous software agent system 100 also provides a problems tab which lists errors, warnings, and information for computer code (in the editor tab) for a user to efficiently see errors in computer code or jump to problematic portions of computer code), an output tab (e.g., shows logs and messages from the IDE or extensions of the IDE to be notified of background activities like loading data onto a server or plugin operations), a debug console (e.g., allows for interactions with a program during debugging, such as viewing runtime logs, evaluating expressions, or inspecting variables), a terminal (e.g., a built-in shell/command-line interface for executing/submitting commands to a terminal, such as running scripts or installing packages), and a version control tab (e.g., provides information as to which devices submitted changes to a code repository and why the changes were submitted to a code repository).

In one or more embodiments, the autonomous software agent system 100 receives one or more inputs to modify computer code in the integrated development environment 312 from a third-party messaging application. In particular, the autonomous software agent system 100 provides outputs (e.g., computer code) from the autonomous software agent 306 utilizing the integrated development environment 312. Moreover, the autonomous software agent system 100 provides the outputs to a third-party messaging application. Additionally, the autonomous software agent system 100 can receive user inputs to the outputs provided to the third-party messaging application. In response to a selection to intervene, the autonomous software agent system 100 can allow a user to write computer code (e.g., in place of the autonomous software agent 306) and to further submit the computer code via the third-party messaging application.

Accordingly, FIG. 3 shows the autonomous software agent system 100 generating artificial intelligence output(s) 316. In particular, FIG. 3 shows the autonomous software agent system 100 utilizing the autonomous software agent 306 to access/switch between the shell tool 308, the browser tool 310, the integrated development environment 312, and/or the planner tool 314 to generate the artificial intelligence output(s) 316 that are responsive to the prompt 302.

More specifically, in one or more embodiments, the autonomous software agent system 100 is configured to automatically (e.g., without further user instructions other than the prompt defining the software task) perform an assigned software task using coordinated interaction among planner tool 314, browser tool 310, an integrated development environment (IDE) 312, a shell tool 308, and an independent virtual machine computing environment. For example, upon receiving a software task—expressed in natural language, structured specification, source code fragment, test case, or other machine-interpretable format—the autonomous software agent system 100 provides the software task to planner tool 314. The planner tool 314 analyzes the objective and generates a structured execution plan comprising an ordered set of subtasks, dependency relationships, required tools, expected outputs, and validation criteria. The execution plan may define actions such as retrieving documentation, generating source code, creating files, compiling code, executing tests, debugging failures, refactoring modules, or deploying artifacts. The autonomous software agent system 100 executes the structured plan within the independent virtual machine computing environment. Where plan steps require external information or dependency retrieval, the autonomous software agent system 100 invokes the browser tool 310 within the independent virtual machine computing environment. The autonomous software agent system 100 uses the browser tool 310 to retrieve and parse remote documentation, API specifications, repositories, or other network-accessible resources and returns structured, machine-readable representations to autonomous software agent system 100 for reasoning and code synthesis.

For code authoring and modification operations, the autonomous software agent system 100 interacts with the IDE 312. The IDE 312 enables creation, editing, refactoring, and organization of source files, as well as invocation of compilers, interpreters, build systems, static analysis tools, and test frameworks. The IDE 312 provides structured diagnostics, including syntax errors, semantic warnings, dependency conflicts, and build logs, which are returned to autonomous software agent system 100. Where system-level commands are required, autonomous software agent system 100 issues instructions through the shell tool 308 executing within the independent virtual machine computing environment. The shell tool 308 enables file system manipulation, dependency installation, build execution, test invocation, process control, and other operating system-level operations. Structured outputs including exit codes, logs, and error streams are returned to autonomous software agent system 100.

The planner tool 314, in one or more implementations, monitors intermediate results generated by the IDE 312, browser tool 310, and shell tool 308, and compares those results against plan-defined success criteria. If discrepancies, failures, or unexpected states are detected, the planner tool 314 automatically revises the execution plan, generates corrective subtasks, reorders actions, or initiates debugging procedures. This iterative loop continues until the software task satisfies defined completion conditions or termination criteria. In this manner, autonomous software agent system 100 autonomously decomposes, executes, validates, and refines development actions within the independent virtual machine computing environment 204 using coordinated tool invocation and structured feedback processing.

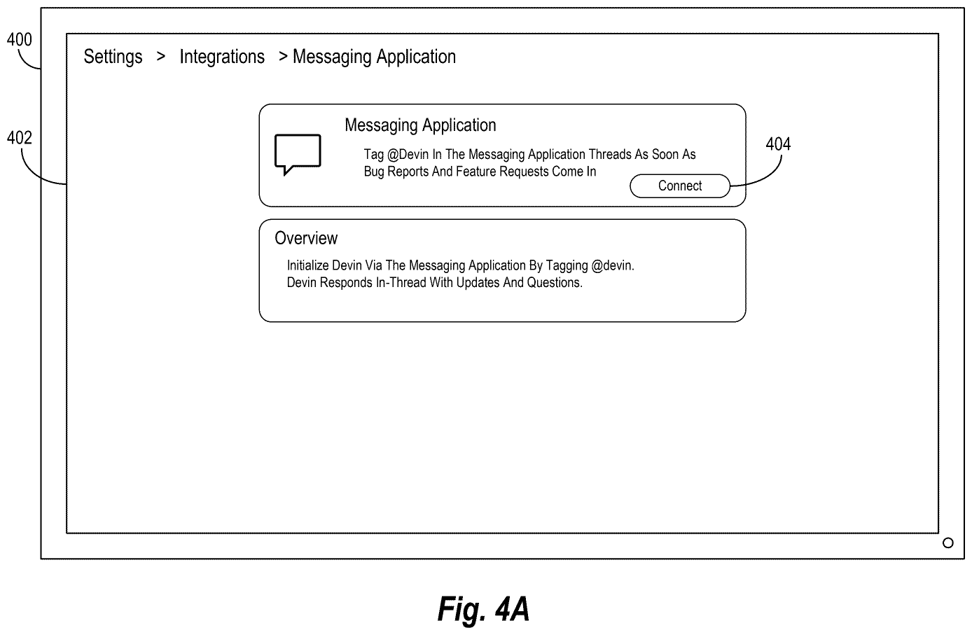

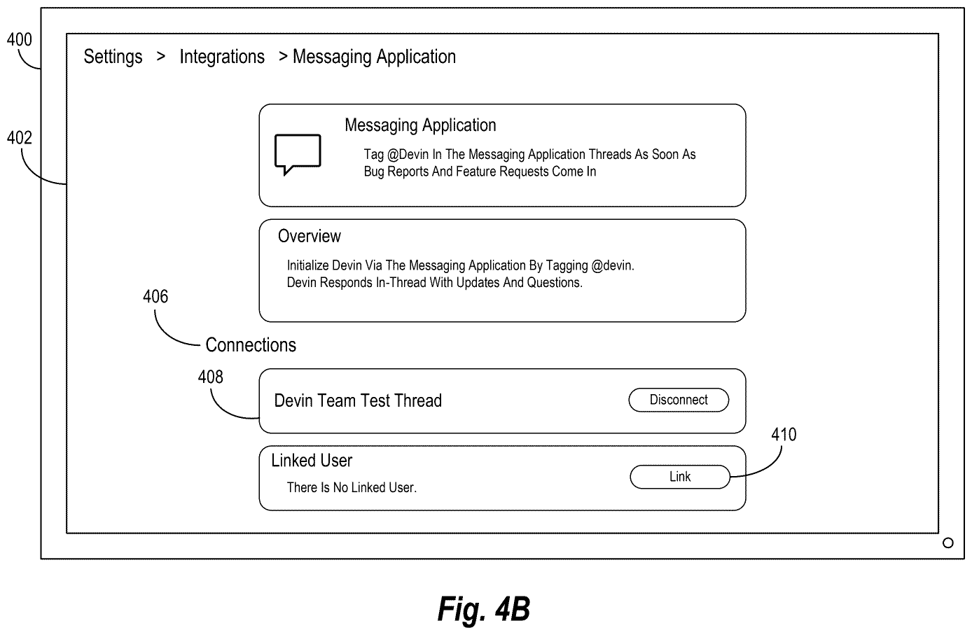

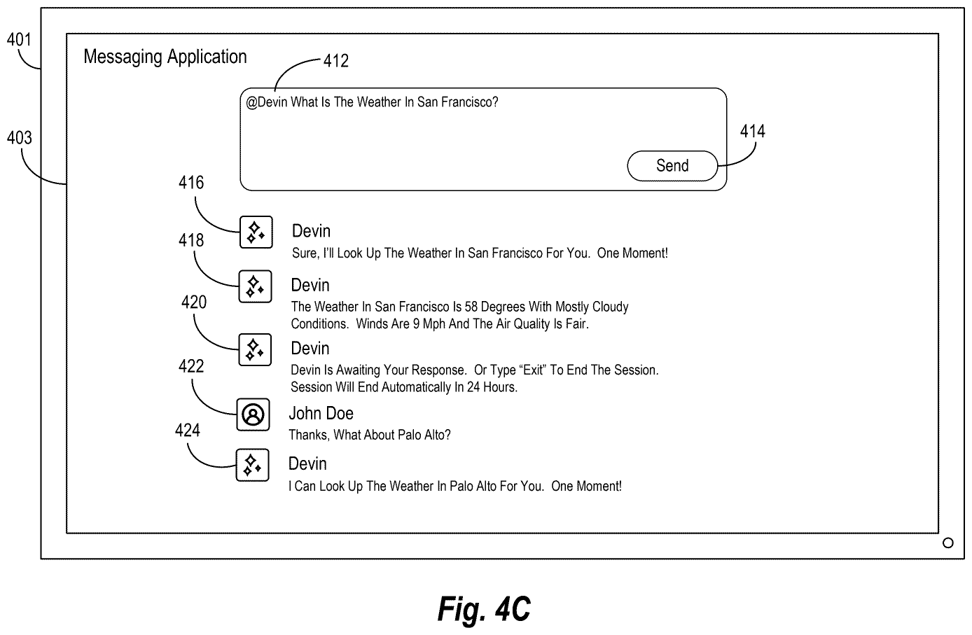

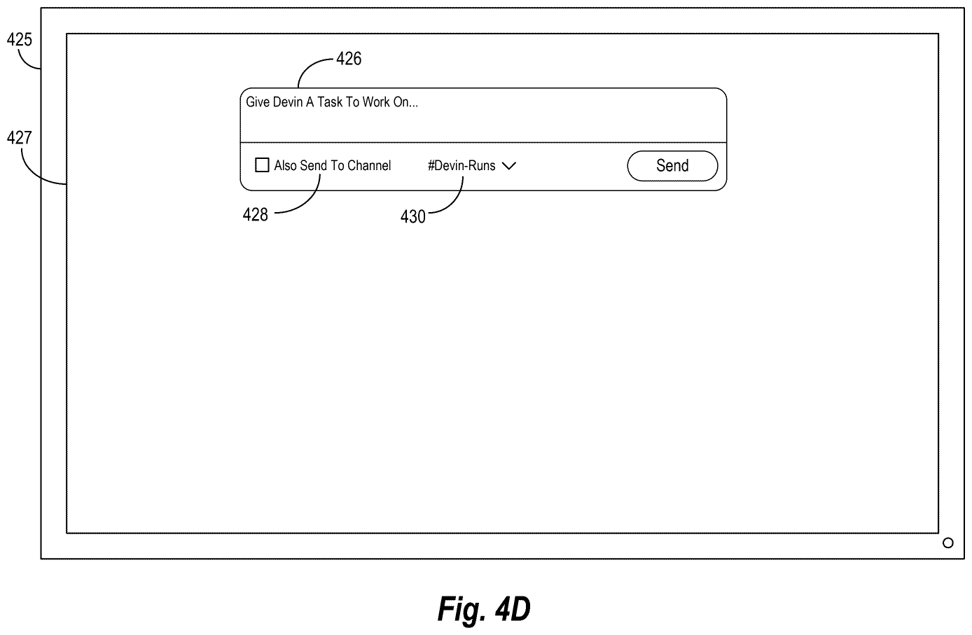

FIG. 4A illustrates a messaging application integration with the autonomous software agent system 100 in accordance with one or more embodiments. For example, FIG. 4A shows that the autonomous software agent system 100 provides to a graphical user interface 402 of a user computing device 400 an interface for organization integrations on a settings page. In particular, if a user selects a connect element 404, the autonomous software agent system 100 can begin a process of connecting/integrating with a third-party messaging application.

Further, FIG. 4B shows the graphical user interface 402 displaying a connection 406 between the autonomous software agent system 100 and a third-party messaging application. In particular, FIG. 4B shows a disconnect element 408, to remove the connection/integration between the autonomous software agent system 100 and the third-party messaging application. Additionally, FIG. 4B shows a link element 410 to link a user. In particular, the link element 410 enables a specific user account corresponding to the user computing device 400 to call/mention/tag the autonomous software agent system 100 within the third-party messaging application (e.g., to deploy an autonomous software agent to execute a software task).

FIG. 4C shows a conversation within a third-party messaging application with the autonomous software agent system 100. For example, FIG. 4C shows a graphical user interface 403 of a user computing device 401 displaying a third-party messaging application. In particular, FIG. 4C shows a prompt 412 (e.g., @Devin what is the weather in San Francisco?) and a send element 414 to submit the prompt 412. Furthermore, FIG. 4C shows a first response 416 (e.g., sure I'll look up the weather in San Francisco for you. One moment!), a second response 418 (e.g., the weather in San Francisco is 58 degrees with mostly cloudy conditions. Winds are 9 mph, and the air quality is fair), a third response 420 (e.g., Devin is awaiting your response. Or type “Exit” to end the session. Session will end automatically in 24 hours).

Furthermore, FIG. 4C shows an additional prompt 422 (e.g., from John Doe who in some embodiments corresponds with the user computing device 401 and in some embodiments, corresponds with a different user computing device). In particular, the additional prompt 422 includes another request for the weather in a different city. In response, FIG. 4C shows the autonomous software agent system 100 generates a fourth response 424.

As just mentioned, the autonomous software agent system 100 can receive a plurality of different messages/prompts from the messaging application from a plurality of different users. For example, FIG. 4C shows the prompt 412 and the additional prompt 422. In some embodiments, the additional prompt 422 pertains to the software task to modify artificial intelligence outputs responsive to the prompt 412, where the prompt 412 corresponds to a first user of the plurality of users and the additional prompt 422 corresponds to a second user of the plurality of users.

FIG. 4D shows a graphical user interface 427 of a user computing device 425 displaying a prompt input element 426. In particular, the prompt input element 426 allows the user computing device 401 to submit a request to the autonomous software agent system 100 via a web browser chat interface. In contrast to FIG. 4C, the web browser chat interface is a chat interface hosted by the autonomous software agent system 100 in order for the user computing device 425 to interact directly with the autonomous software agent system 100.

In particular, FIG. 4D shows a send to channel element 428 and a channel selection element 430. For example, the channel selection element 430 allows the user computing device 425 to select a specific conversation thread within a third-party messaging application (shown above) and a selection of the send to channel element 428 causes the autonomous software agent system 100 to transmit/synchronize conversations within the web browser to be within the third-party messaging application. Additionally, the autonomous software agent system 100 can directly send outputs (e.g., artificial intelligence outputs and/or progress status updates) to the selected conversation channel within the third-party messaging application. In other words, a plurality of users are able to use the “send to channel” feature which mirrors sessions started via the web application within the third-party messaging application.

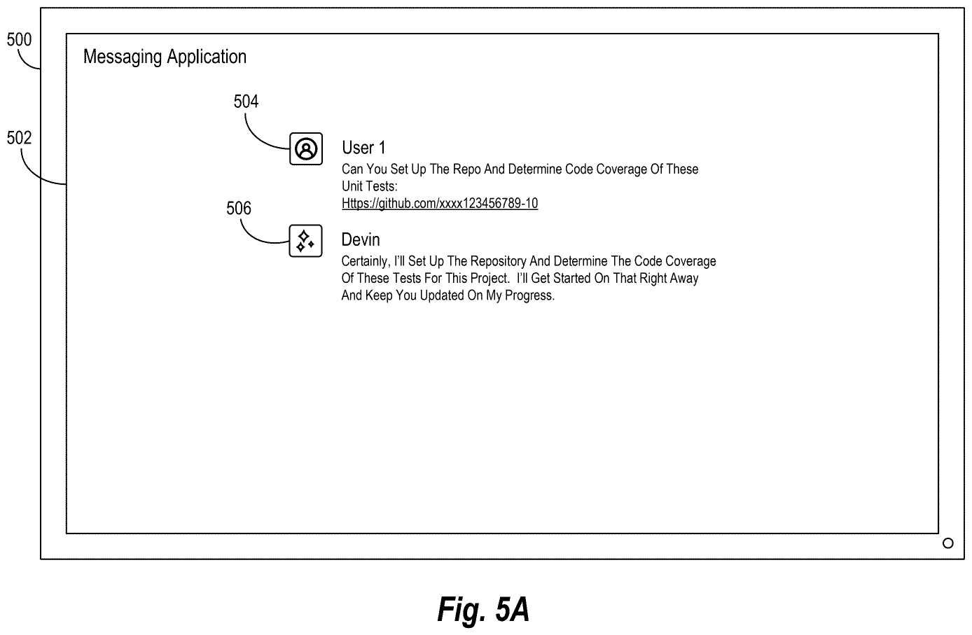

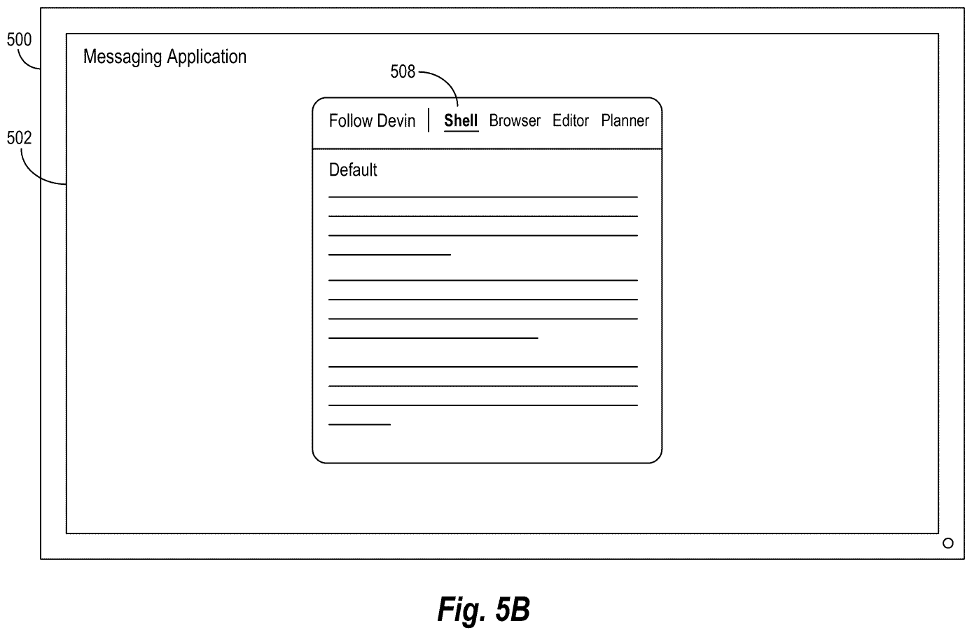

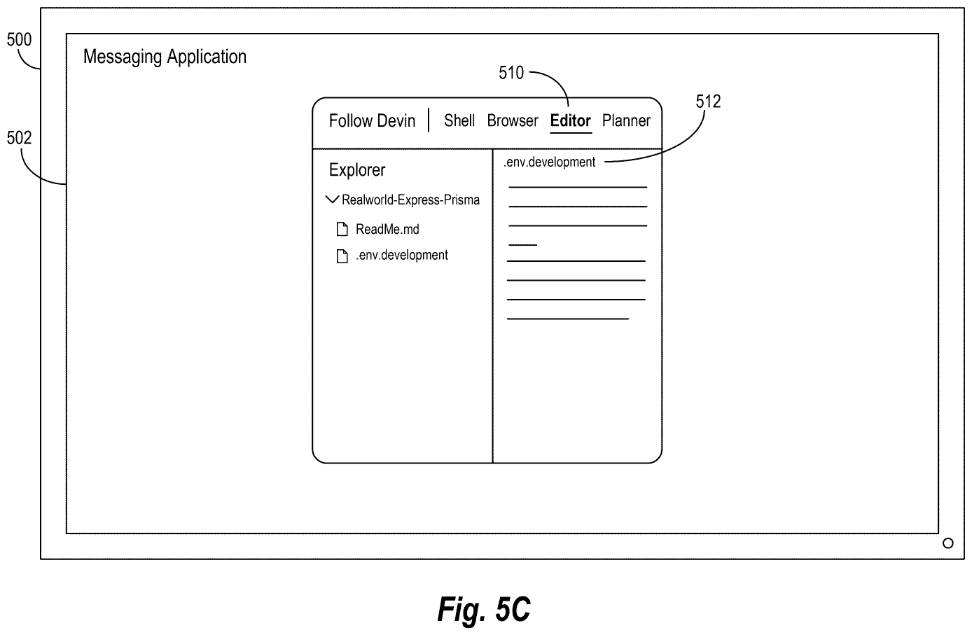

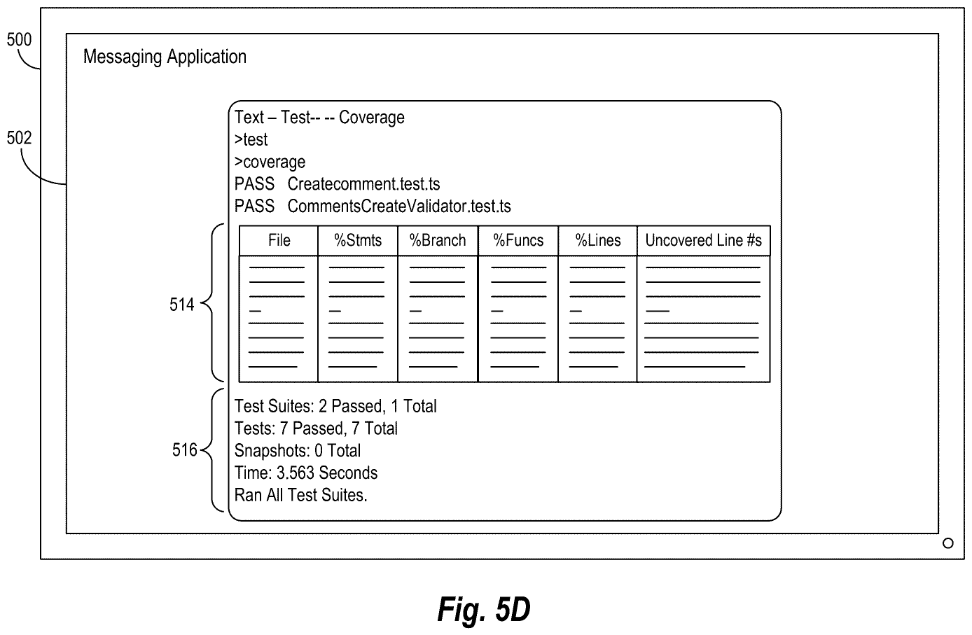

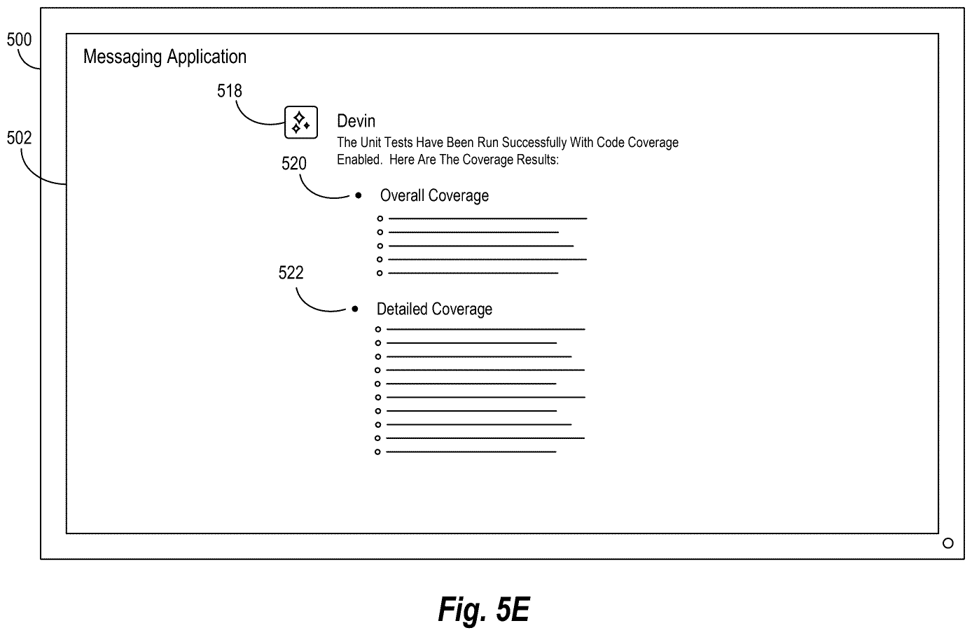

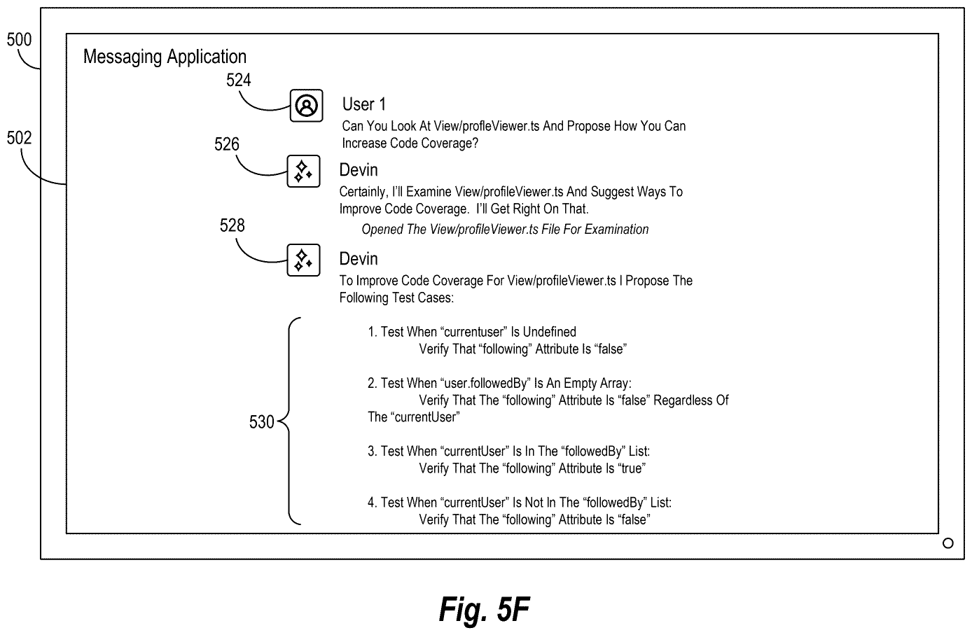

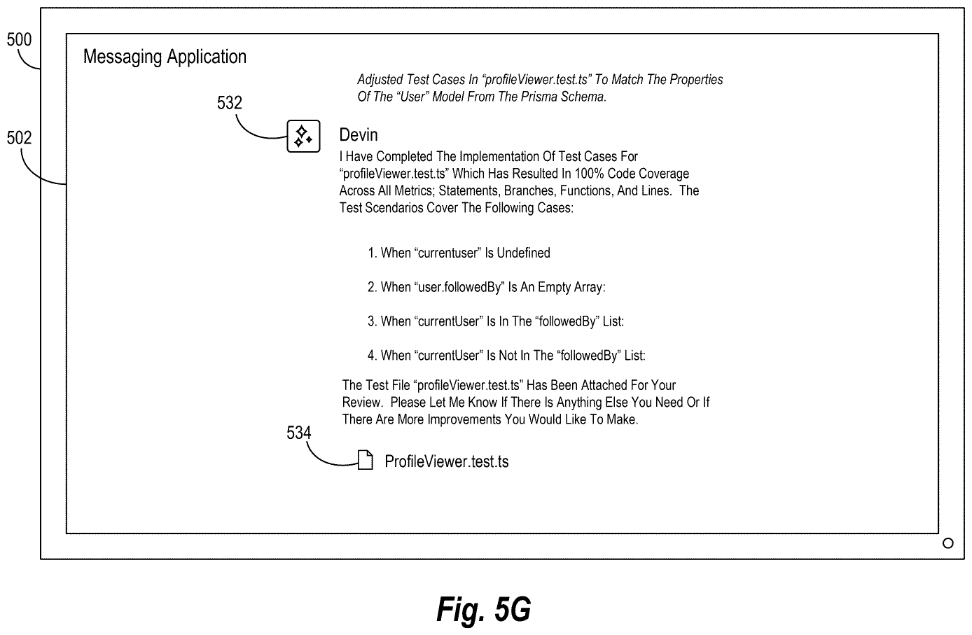

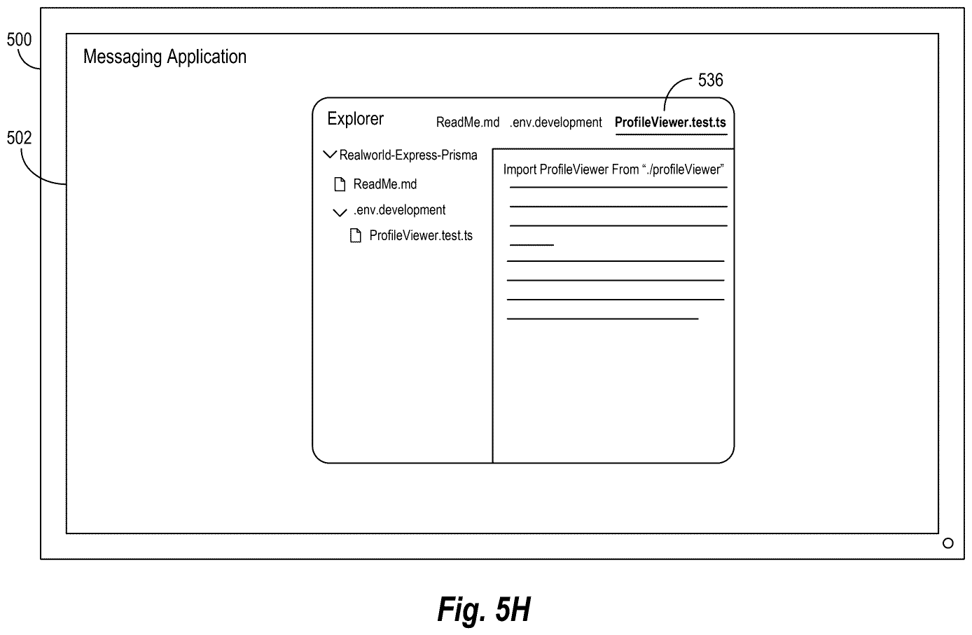

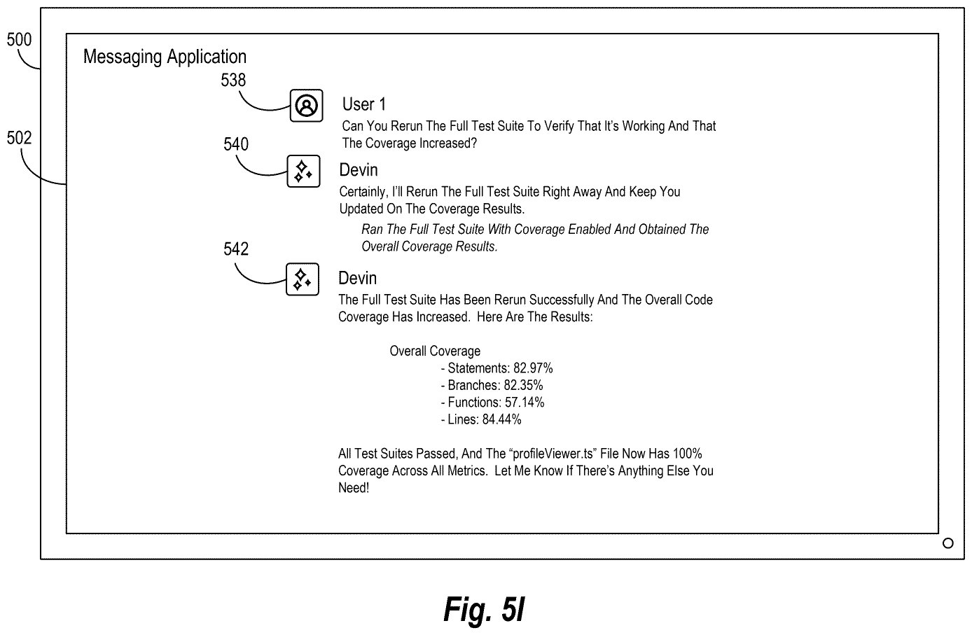

FIGS. 5A-5I illustrate the autonomous software agent system 100 analyzing a codebase test suite and writing additional tests to increase code coverage in accordance with one or more embodiments. FIG. 5A shows a graphical user interface 502 of a user computing device 500 displaying a prompt 504 (e.g., can you set up the repo and determine code coverage of these unit tests: . . . ). Further, FIG. 5A shows a response 506 from the autonomous software agent system 100 (e.g., certainly, I'll set up the repository and determine the code coverage of these tests for this project. I'll get started on that right away and keep you updated on my progress).

In some embodiments, software applications in production do not have full code coverage. In other words, software applications typically do not have executed and verified results for each executable statement, line, and branch in a codebase. As such, engineering teams typically have to prioritize and focus on writing tests for critical paths to get the most benefit out of the time spent. In one or more embodiments, the autonomous software agent system 100 bridges this gap of lacking full code coverage by analyzing a codebase's existing test suite style and increasing coverage of less critical but important functions. As shown in FIG. 5A, the autonomous software agent system 100 can receive an initial prompt that directs the autonomous software agent system 100 to set up a development environment and to assess the existing code coverage of a software application.

As shown in FIG. 5B, the autonomous software agent system 100 accesses a shell tool 508 to execute the prompt shown in FIG. 5A. For example, the autonomous software agent system 100 can utilize the shell tool 508 to first clone a code repository from code repository management system, parse a README file, and install project dependencies in an autonomous software agent's local environment (e.g., independent virtual machine computing environment).

Moreover, as shown in FIG. 5C, the autonomous software agent system 100 accesses an editor tool 510 (e.g., an integrated development environment) and writes computer code related to an open project 512. For example, the autonomous software agent system 100 can use its built-in editor tool to create an .env file so that a software application can be run locally (e.g., for testing). Further, as mentioned above, when using the autonomous software agent system 100, the user computing device 500 has the ability to open the editor tool 510 to perform manual edits or to review the files that the autonomous software agent system 100 is working on.

As shown in FIG. 5D, the autonomous software agent system 100 can utilize the shell tool discussed above to run a plurality of tests. In particular, FIG. 5D shows terminal commands 514 and terminal command results 516. For example, the autonomous software agent system 100 can run a test suite in its shell tool and directly submit terminal commands to perform higher level interactions with a codebase, a development environment, or even a running application.

Further, FIG. 5E shows how the autonomous software agent system 100 interprets and translates the results from its shell into a chat interface. In particular, FIG. 5E shows an additional response 518 from the autonomous software agent system 100 within a chat interface that shows overall coverage 520 and detailed coverage 522 from the autonomous software agent system 100 running the test suite. In some embodiments, the autonomous software agent system 100 translates artificial intelligence outputs to be more human readable and distilled.

As shown in FIG. 5F, the autonomous software agent system 100 receives an additional prompt 524 (can you look at view/profileViewer.ts and propose how you can increase code coverage?), generates an additional response 526 (the autonomous software agent system 100 will suggest ways to improve code coverage), and another response 528 with a detailed plan 530 for responding to the additional prompt 524.

As shown in FIG. 5F, the autonomous software agent system 100 can generate the detailed plan 530 that is an improvement plan for increasing code coverage. In some embodiments, the autonomous software agent system 100 attempts to increase code coverage by looking at profile Viewer.ts. As shown in FIG. 5F, the autonomous software agent system 100 starts with the profileViewer.ts and proposes various different test cases (e.g., current user is undefined, user.followedBy is an empty array, currentUser is in the followedBy list, and currentUser is not in the followedBy list).

Additionally, as shown in FIG. 5G, the autonomous software agent system 100 finishes implementing the new test cases and generates/provides a rundown of changes that the autonomous software agent system 100 performed. For example, FIG. 5G shows a response 532 of the autonomous software agent system 100 completing the implementation of new test cases and further generates an attached file 534 that shows the test cases.

As shown in FIG. 5H, the autonomous software agent system 100 further shares a new file 536 with the user computing device 500 so that the user computing device 500 can download and review the new file 536. In some embodiments, the user computing device 500 can prompt the autonomous software agent system 100 to create a pull request directly within a code repository management system with the new file 536 so that the new file 536 can be reviewed as part of a code review process undertaken by software developers.

As shown in FIG. 5I, the autonomous software agent system 100 further receives additional prompts to identify runtime code bugs. For example, FIG. 5I shows a prompt 538 (e.g., can you rerun the full test suite to verify that its working and that the coverage increased?) a response 540, and an additional response 542 (e.g., that shows results of increased code coverage). Accordingly, the autonomous software agent system 100 performs runtime tests to verify the viability of the code.

In one or more embodiments, FIGS. 5A-5I illustrate experimental results that the autonomous software agent system 100 increases overall code coverage from 28.57% of computer code functions to 57.14% of computer code functions. In some embodiments, the entire process shown in FIGS. 5A-5I takes less than ten minutes of work by an autonomous software agent of the autonomous software agent system 100 to implement.

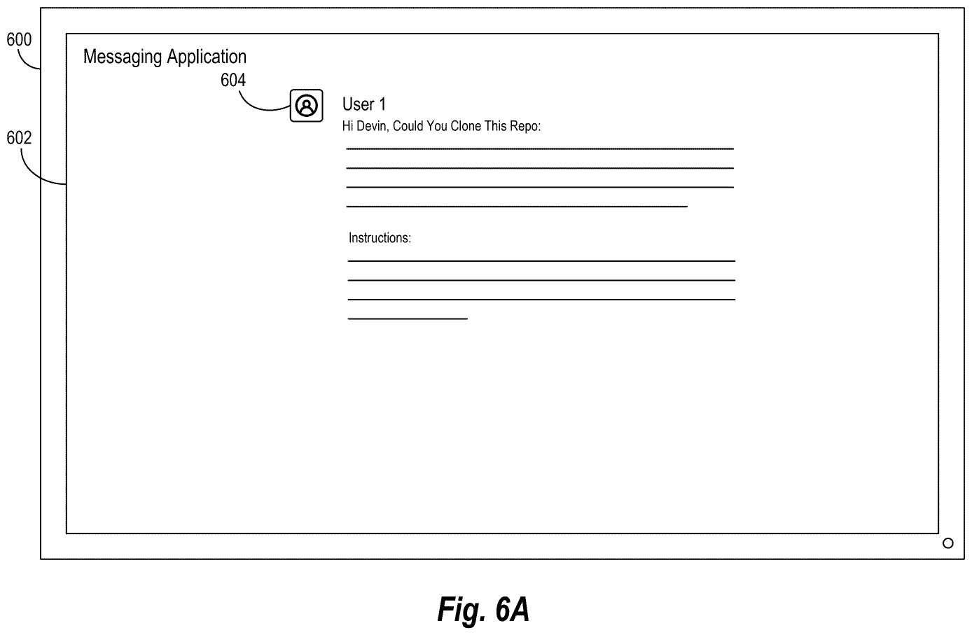

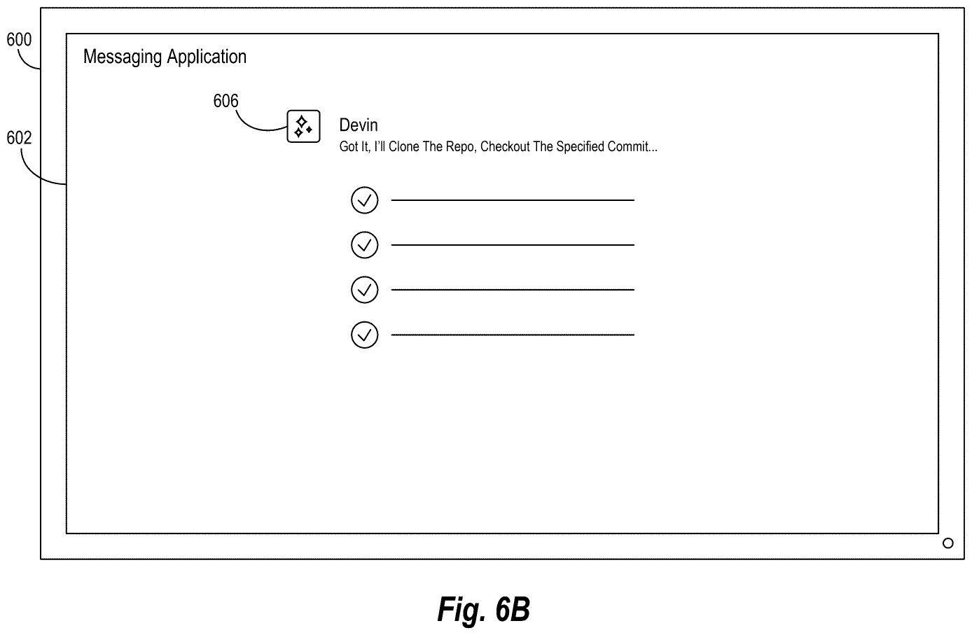

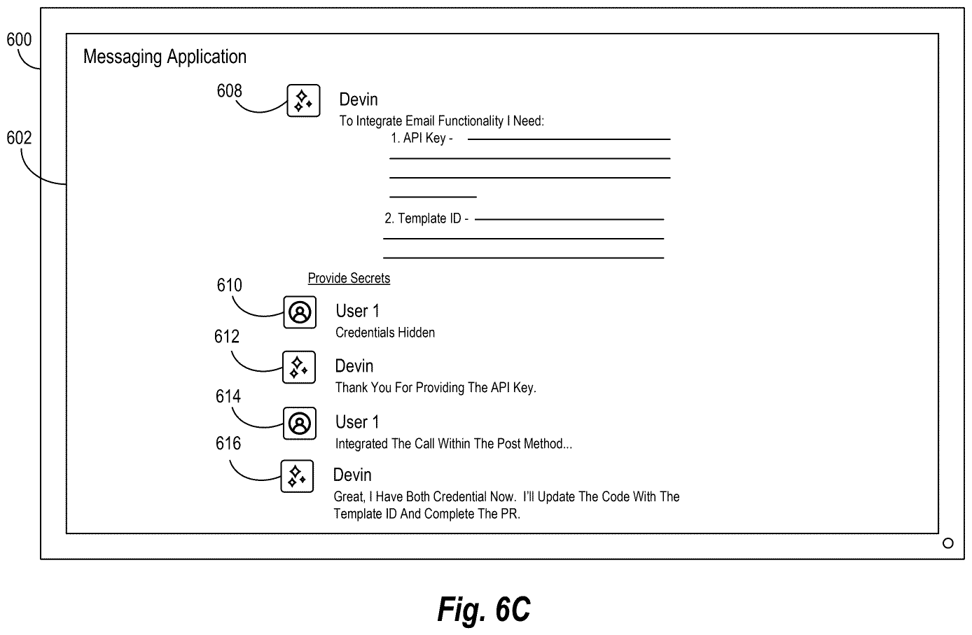

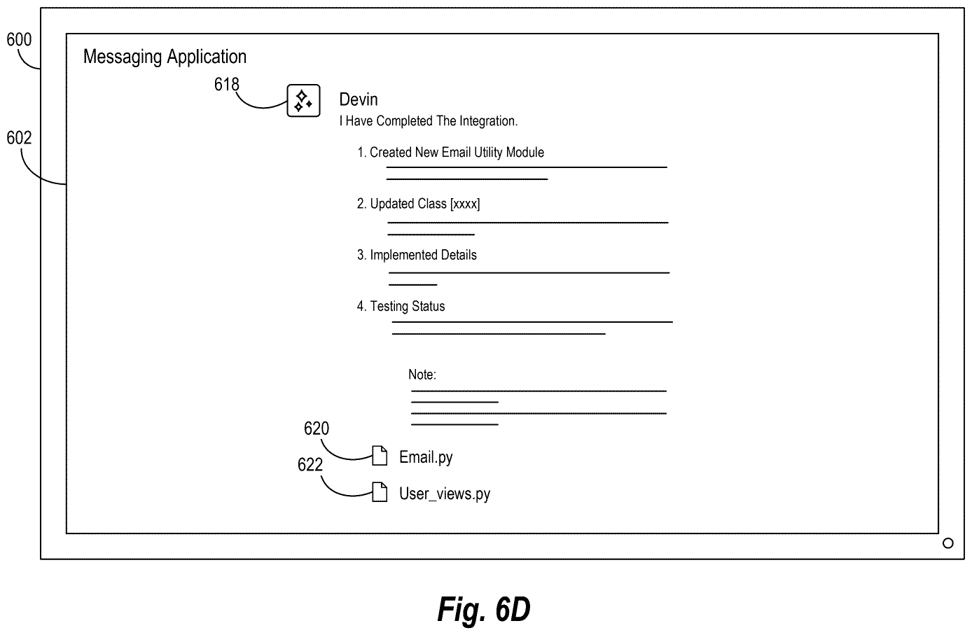

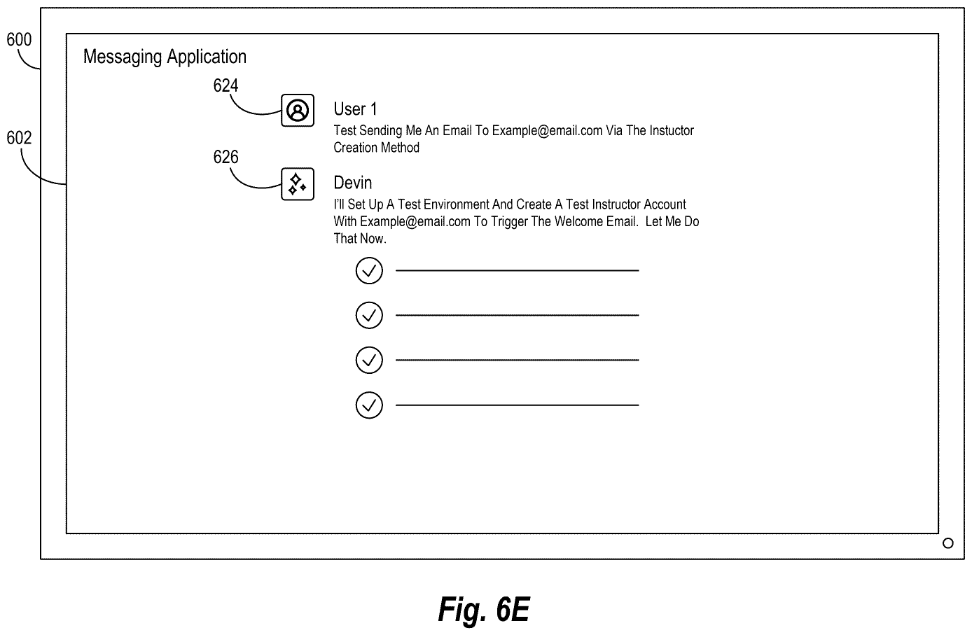

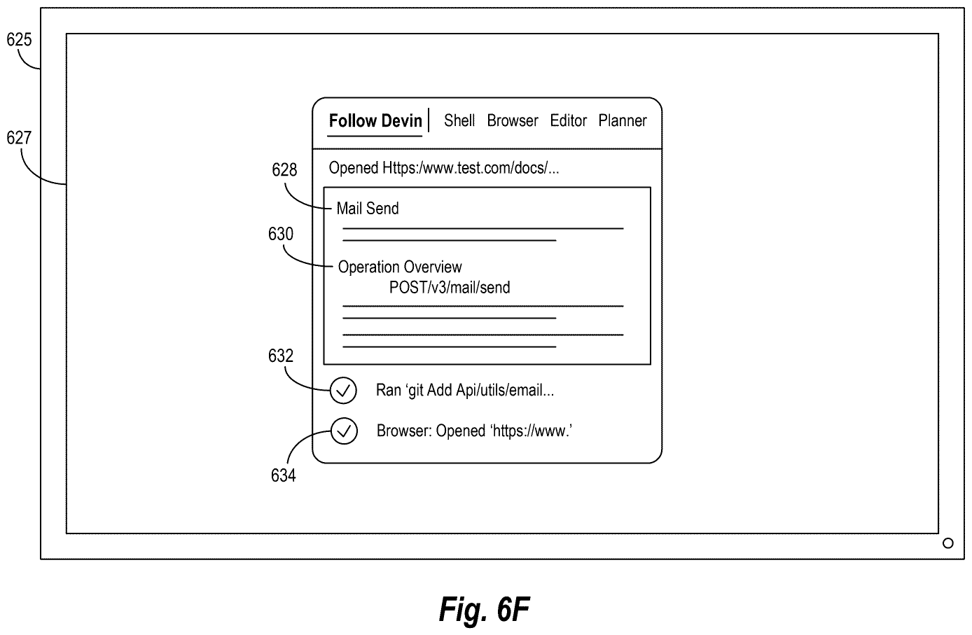

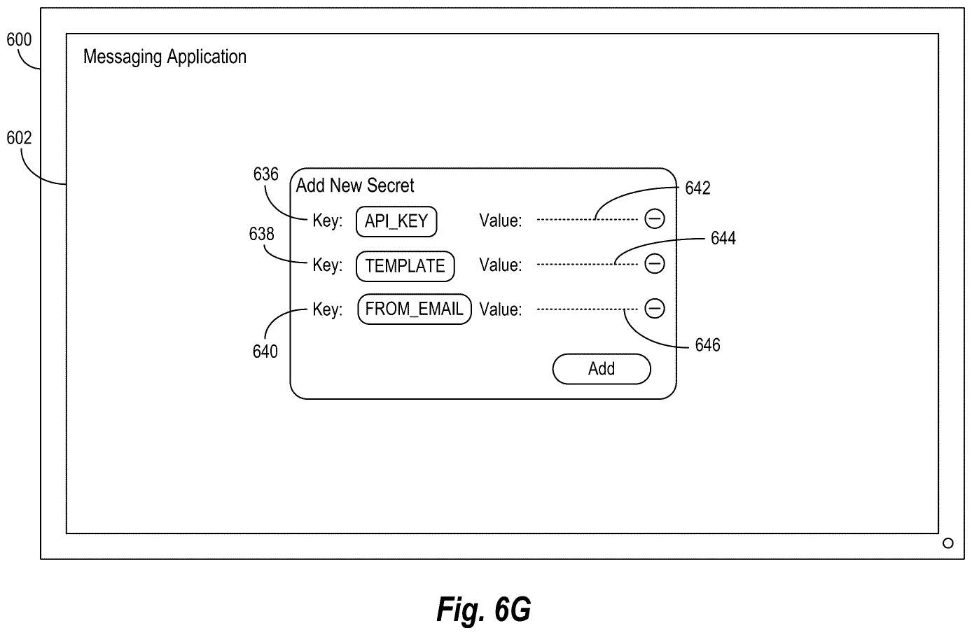

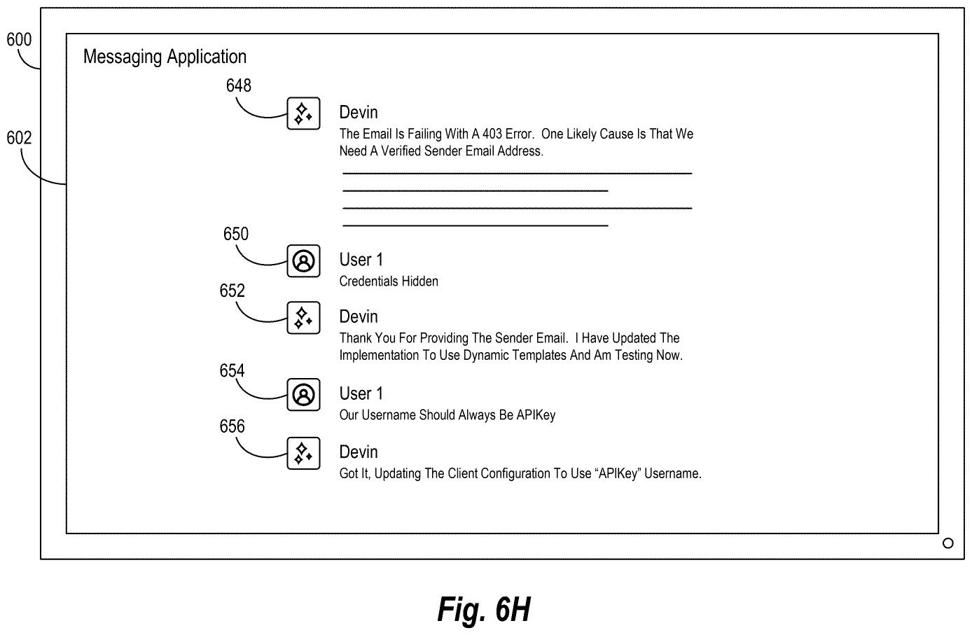

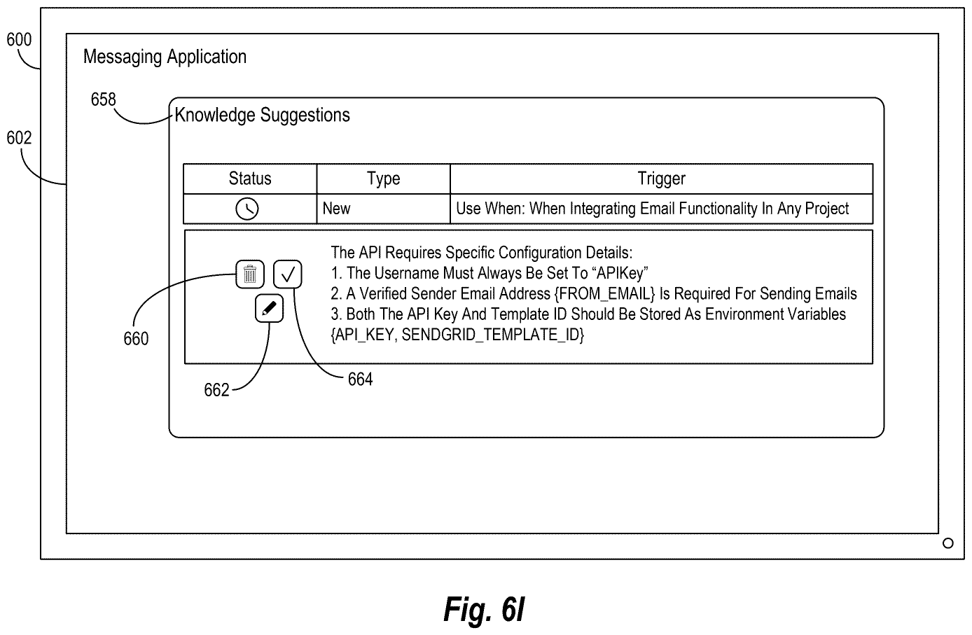

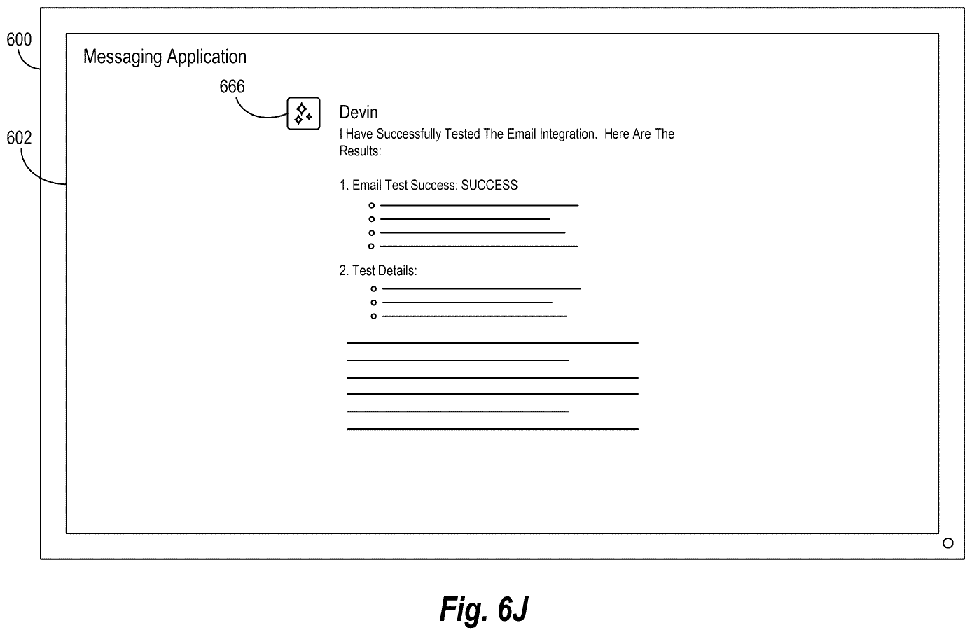

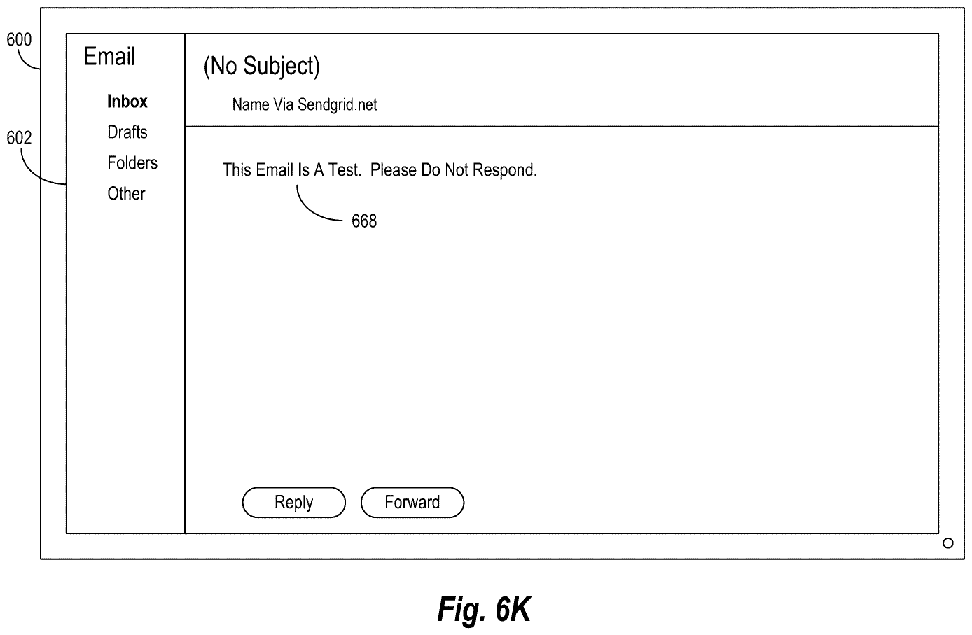

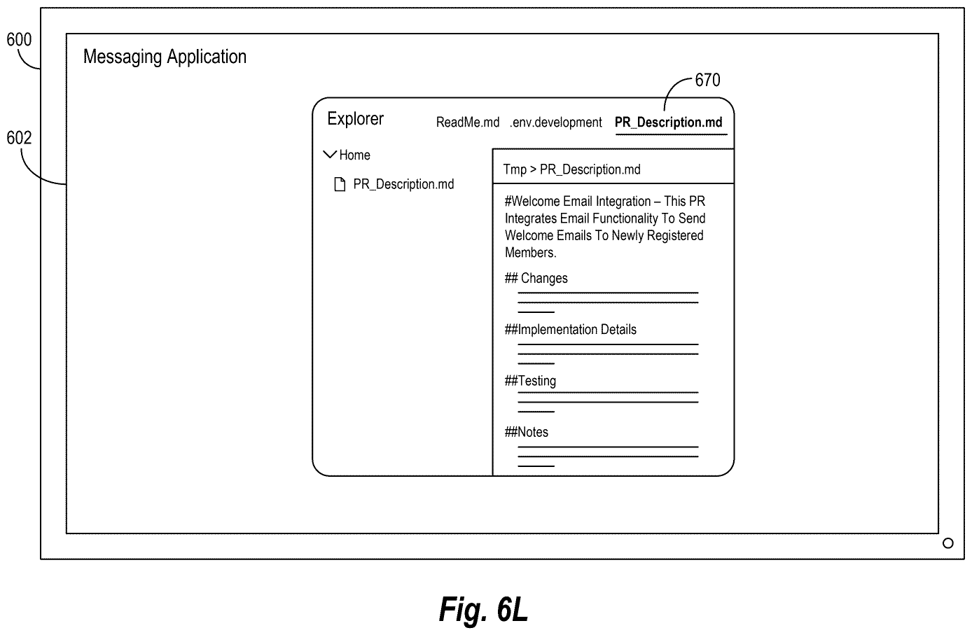

FIGS. 6A-6L illustrate the autonomous software agent system 100 performing an API integration (e.g., application programming interface integration) to test third party APIs in accordance with one or more embodiments. As an illustrative example, the software task for FIGS. 6A-6L can include a sample software application for an online educational platform written with a Python web framework. Moreover, the illustrative example can include a pull request that was recently opened to integrate an email API with the online educational platform application. In particular, the software task can include the autonomous software agent system 100 implementing with the online educational platform to showcase how the autonomous software agent system 100 works with third party APIs.

For example, FIG. 6A shows a graphical user interface 602 of a user computing device 600 displaying a prompt 604 from the user computing device 600. In particular, FIG. 6A shows the prompt 604 as including a request to clone a code repository with corresponding instructions. For example, the autonomous software agent system 100 can receive specific instructions about integrating a webhook for a third-party application programming interface. In some embodiments, the prompt 604 specifies that the autonomous software agent system 100 can revert to an earlier commit within a code repository before a previous pull request was merged to provide a clean starting point for an integration with the third-party API.

As shown in FIG. 6B, the autonomous software agent system 100 provides a response 606 within a third-party messaging application. In particular, the autonomous software agent system 100 indicates that it will clone the code repository and check out the specified code commit. For example, based on the illustrative example above, the autonomous software agent system 100 can investigate the codebase and ensure that there is no conflicting email implementation that already exists in the application.

Moreover, FIG. 6C shows the autonomous software agent system 100 generating a response 608 and providing the response 608 to the third-party messaging application. In particular, the autonomous software agent system 100 generates the response 608 to request the user computing device 600 to provide an API key and a template identifier to integrate the email functionality.

Additionally, FIG. 6C shows a first user response 610 where the autonomous software agent system 100 receives access credentials (e.g., the API key) from the user computing device 600 and the autonomous software agent system 100 generates a second response 612 indicating that the autonomous software agent system 100 has received the access credentials. Furthermore, FIG. 6C shows the autonomous software agent system 100 receiving a second user response 614 that the call has been integrated within the post method. Moreover, FIG. 6C shows the autonomous software agent system 100 generating a third response 616 that the autonomous software agent system 100 has received both credentials and that the autonomous software agent system 100 will update the code with the template identifier and complete the pull request.

To further illustrate based on the above illustrative example, the autonomous software agent system 100 moves on to implementing the third-party API and prompts the user computing device 600 for API credentials. In particular, the user computing device 600 can set up the credentials in an access credentials manager of the autonomous software agent system 100 such that the autonomous software agent system 100 may access the credentials as environment variables.

Further, FIG. 6D shows the autonomous software agent system 100 generating a message 618 to provide to the third-party messaging application. In particular, FIG. 6D shows the message 618 as indicating that the autonomous software agent system 100 has completed the integration. For example, the message 618 indicates that the autonomous software agent system 100 has created a new email utility module, has updated a specific class, implementation details, and testing status. Additionally, FIG. 6D shows a first attachment 620 and a second attachment 622 based on the executed software task of integrating with a third-party API. Accordingly, FIG. 6D illustrates the autonomous software agent system 100 obtaining the proper API credentials and finishing the implementation with a third-party software application.

In one or more embodiments, when a message from the third-party messaging application 104 includes a file attachment, the autonomous software agent system 100 retrieves file metadata via an application programming interface and downloads file contents using an authorized request. Retrieved files may include logs, configuration files, source code, or other artifacts referenced within the message. In some embodiments, downloaded files are stored temporarily for processing and deleted after completion of the development session, thereby limiting persistent storage of messaging-originated content.

With its core implementation finished, FIG. 6E shows that the autonomous software agent system 100 can further receive a prompt 624 to test the application by adding an instructor account under an email address. Further, as shown in a response 626 of FIG. 6E, to test the application, the autonomous software agent system 100 will go through and install/configure all of the dependencies (e.g., PostgreSQL server and relevant Python libraries).

Moreover, FIG. 6F shows a graphical user interface 627 of a user computing device 625, where in some embodiments, the graphical user interface 627 is a web browser application of the autonomous software agent system 100. In particular, FIG. 6F shows the web browser application of the autonomous software agent system 100 following an autonomous software agent. For example, FIG. 6F shows a mail send 628, an operation overview 630, a first development status 632 and a second development status 634 of executing a software task of testing the integration with the third-party application.

To illustrate, FIG. 6F shows that the autonomous software agent system 100 quickly encounters an error, which is because it was not provided with a FROM address for the third-party software application account. In response, the autonomous software agent system 100 navigates to using a browser tool to access the API documents to figure out the error and understand the error message/best implementation practices.

FIG. 6G shows the autonomous software agent system 100 receiving a first access credential 636, a second access credential 638, and a third access credential 640 from an access credentials manager. Further, FIG. 6G shows a first token 642 corresponding to the first access credential 636, a second token 644 corresponding to the second access credential 638, and a third token 646 corresponding to the third access credential 640. To illustrate, in some embodiments, the autonomous software agent system 100 receives a FROM_EMAIL variable to execute the task of testing the integration with the third-party software application.

Moreover, FIG. 6H shows the autonomous software agent system 100 generating a response 648 that the email is failing with a 403 error, which is one likely caused by needing a verified sender email address. Furthermore, FIG. 6H shows a user response 650 of the user computing device 600 providing access credentials, the autonomous software agent system 100 generating a response 652 of the autonomous software agent system 100 receiving the sender email, a user response 654 of clarification instructions, and a response 656 of the autonomous software agent system 100 acknowledging the clarification instructions.

To illustrate, the autonomous software agent system 100 can receive the clarification instructions of using the default third-party software application username as an ‘apikey’ since there is not a subaccount set up for the API. Further, FIG. 6I shows that the autonomous software agent system 100 observes that the request and implementation requirements are generalizable and prompts the user to add knowledge that it can use in the future. In particular, FIG. 6I shows knowledge suggestions 658 a confirm option element 664, an edit option element 662, and a delete option element 660. To illustrate, if the user computing device 600 adds this knowledge, the user computing device 600 can also edit the knowledge to add even more specifics if these tactics are useful for future sessions.

FIG. 6J shows the autonomous software agent system 100 generating a response 666 that the autonomous software agent system 100 has successfully tested the email integration with the corresponding results from performing the testing. Moreover, FIG. 6K shows that after a few minutes of environment configuration and setup, the autonomous software agent system 100 finishes its successful session by sending an email message 668. Furthermore, FIG. 6L shows that if the user computing device 600 chooses to submit a pull request 670, the autonomous software agent system 100 has already drafted a message for the user to include details of everything that has been changed in the application and how it works.

In one or more embodiments, the autonomous software agent system 100 defines a plurality of keywords and functions for the third-party messaging application to communicate with the autonomous software agent system 100. In particular, the autonomous software agent system 100 defines the plurality of keywords and functions to include defined text shortcuts to cause an autonomous software agent of the autonomous software agent system 100 to perform specific types of tasks.

In one or more embodiments, the autonomous software agent system 100 enables anyone in a messaging channel (e.g., with linked user access) of a third-party messaging application to quickly follow along and collaborate with the autonomous software agent system 100. In one or more embodiments, the autonomous software agent system 100 defines the following inline keywords and functions to improve the efficiency of using a third-party messaging application integrated with the autonomous software agent system 100:

| Keyword | Function |
|---|---|
| mute | prevents Devin from seeing further third- |
| | party messaging application messages in |
| | a thread. |
| Unmute | Reverses the above mute keyword |
| | function. |
| (aside), !aside | causes the autonomous software agent |
| | system 100 to ignore the message |
| | (useful for commenting on an autonomous |
| | software agent's run directly in-thread). |
| sleep | puts the autonomous software agent |
| | system 100 to sleep; to wake the |
| | autonomous software agent system 100 |
| | up, a user can send any message in |
| | the thread |
| archive | puts the autonomous software agent |
| | system 100 to sleep + archives |
| | the session. |
| !ask | A user computing device can begin their |
| | message with !ask to get a quick |
| | codebase answer without starting a full |
| | development session with an autonomous |
| | software agent |
| !deep | A user computing device can get a deeper |
| | research answer using advanced search |
| EXIT | Ends the development session of the |
| | autonomous software agent system 100. |
| snapshot: <snapshot name> | Use a particular snapshot (e.g., a machine |
| | state) with your run from a virtual |
| | machine snapshot library to initialize |
| | a custom environment for an autonomous |
| | software agent. |
| playbook: <playbook-name> | Use a particular playbook (e.g., a reusable |
| | system prompt) with a particular |
| | development session. |

As mentioned above, in one or more embodiments, a user computing device can enable third-party messaging application notifications for specific runs and the autonomous software agent system 100 will privately message the user computing device (e.g., via the third-party messaging application) whenever there is a status update. To enable this notification, the autonomous software agent system 100 receives from a user computing device, a selection of “enable third-party messaging notifications” in a menu at the top of a development session. Moreover, in some embodiments, a user computing device can establish a dedicated channel for the autonomous software agent system 100 to keep all conversations with the autonomous software agent system 100 in one place within the third-party messaging application. In particular, keeping all conversations with the autonomous software agent system 100 in one place assists a software development team to collaborate on development session runs together and to further draw inspiration for different use cases.

Moreover, the following table illustrates various permission details for the autonomous software agent system 100 to read data packets from the third-party messaging application:

| | | Rationale for the |
|---|---|---|
| | | permissions to read |
| | | data packets from |
| | | the third-party |
| Permission | Description | messaging application |
| chat: write, chat: write.customize | Send messages as | The autonomous |
| | @Devin or using | software agent |
| | a customized | system 100 is able |
| | username and avatar. | to respond to user |
| | | requests |
| commands | Add shortcuts and/or | The autonomous |
| | slash commands that | software agent |
| | people within the | system 100 might |
| | messaging application | gain more interactive |
| | can use to give | features in the future |
| | commands to the | that will require |
| | autonomous software | different commands. |
| | agent system 100. | |
| files: read. files: write | Upload, edit, and | The autonomous |
| | delete files as the | software agent |
| | autonomous software | system 100 may need |
| | agent system 100. | to manage files in |
| | | order to send and |
| | | receive attachments |
| | | to/from the user. |
| channels: history, | View messages and | The autonomous |
| groups: history, im: history | other content in | software agent |
| | channels, groups, | system 100 has to |
| | and DMs that the | access historical |
| | autonomous software | messages when it is |
| | agent system 100 | launched inside of a |
| | is in. | message thread in |
| | | order to retrieve the |
| | | previous messages in |
| | | the thread as context. |
| im: read, im: write | Start direct messages | The autonomous |
| | with people and view | software agent |
| | basic information | system 100 needs to |
| | about direct messages | be able to initiate |
| | that the autonomous | DMs in order to send |
| | software agent | users notifications |
| | system 100 has been | via the third-party |
| | added to. | messaging |
| | | application. |
| reactions: write | Add and edit emoji | The autonomous |
| | reactions. | software agent |
| | | system 100 adds |
| | | emojis to messages in |
| | | order to mark runs as |
| | | completed or failed. |
| remote_files: read, | View remote files | The autonomous |
| remote_files: write | added by the app | software agent |
| | in a workspace. | system 100 needs to |
| | | manage remote files |
| | | in order to send and |
| | | receive attachments |
| | | to/from the user. |
| users:read, users: read.email, | View people in a | The autonomous |
| users.profile: read | workspace as well | software agent |
| | as their emails | system 100 needs to |
| | and profiles. | be able to match |
| | | users of a third-party |
| | | messaging application |
| | | with users of the |
| | | autonomous software |
| | | agent system 100 |
| | | based on their email |
| | | addresses. |
| Organization.Read.All | The autonomous | This validates a |
| | software agent | tenant where the |
| | system 100 can read | application is being |
| | basic organization | installed. |
| | profile. | |
| User.ReadBasic.All | The autonomous | This maps member |
| | software agent | identities and |
| | system 100 can read | resolves mentions |
| | basic profiles for | in linked teams. |
| | all users. | |
| AppCatalog.Read.All | The autonomous | This allows the |
| | software agent | autonomous software |
| | system 100 can read | agent system 100 to |
| | an application | locate an application |
| | catalog. | and fetch an |
| | | identifier required for |
| | | installation. |
| AppInstallation.ReadWriteAndConsentSelf.All | The autonomous | This allows the |
| | software agent | autonomous software |
| | system 100 can | agent system 100 to |
| | install/uninstall the | install/remove a |
| | application and grant | bot in a selected |
| | application resource- | application from the |
| | specific consent | dashboard. |
| | (RSC). | |

In some embodiments, the autonomous software agent system 100 utilizes an authentication layer between a third-party messaging application and the autonomous software agent system 100. In particular, the autonomous software agent system 100 utilizes an authentication architecture to create authenticated development sessions for an autonomous software agent. In particular, the autonomous software agent system 100 can utilize certification-based authentication (e.g., a digital certification to verify the identity of a user device or application), token validation (e.g., verifying a security token is legitimate and usable), tenant ID verification (e.g., a verification to verify that a request belongs to a correct tenant in a multi-tenant system), and user identity claims (e.g., pieces of information about a user included in a token) as part of the authentication layer for creating an authenticated development session.

To illustrate, the autonomous software agent system 100 receives a tag/mention from a third-party messaging application and goes through a series of authentication steps that involve the certification-based authentication, token validation, tenant ID verification, and user identity claims before reaching an identity mapping service of the autonomous software agent system 100. In doing so, the autonomous software agent system 100 can create an authenticated development session that leverages an autonomous software agent.

In one or more embodiments, the autonomous software agent system 100 requires administrator tenant-wide consent for connecting a specific user account to a third-party messaging application. In particular, administrator tenant-wide consent grants the aforementioned certification-based authentication. Additionally, in some embodiments, the autonomous software agent system 100 installs a bot within a specific group of the third-party messaging application. In particular, during installation, the autonomous software agent system 100 grants bot resource-specific consent permissions for the specific group. In some embodiments, the autonomous software agent system 100 can revoke a user account from being connected with a third-party messaging application. In particular, the autonomous software agent system 100 can receive a revocation of a user account via an administrator device.

In one or more embodiments, messaging-originated events are routed to a tenant-specific execution environment based on the associated messaging workspace identifier. For example, when an event is received, the autonomous software agent system 100 determines the corresponding tenant or organization account and initiates a development session within a dedicated virtual private cloud (VPC) associated with that tenant. Accordingly, messaging-triggered execution is isolated from other tenants, thereby preserving data separation and execution security.

Furthermore, in some embodiments, the autonomous software agent system 100 can establish bot resource-specific consent permissions. In particular, the bot resource-specific consent permissions relate to an individual user account/user computing device connecting the autonomous software agent system 100 with the third-part messaging application. In other words, the bot resource-specific consent permissions do not apply tenant-wide.

Moreover, the following table illustrates various bot resource-specific consent permissions for the autonomous software agent system 100 to read data packets from the third-party messaging application:

| | | What the | |
|---|---|---|---|
| Permission | Scope | permission allows | Rationale |
| ChannelMessage.Read.Group | Channel | The autonomous | The autonomous |
| | | software agent | software agent |
| | | system 100 can | system 100 can |
| | | read channel | process channel |
| | | messages where | conversations |
| | | the connection is | (summaries, |
| | | installed. | triggers, synching). |
| ChannelMessage, Send.Group | Channel | The autonomous | The autonomous |
| | | software agent | software agent |
| | | system 100 can | system 100 can |
| | | send messages in | respond to |
| | | channels (new | messages in channel |
| | | posts and threaded | threads and |
| | | replies) where the | proactively post |
| | | connection is | updates to channels. |
| | | installed. | |
| Member.Read.Group | Channel | The autonomous | The autonomous |
| | | software agent | software agent |
| | | system 100 can | system 100 can map |
| | | read team | identities, perform |
| | | membership. | permission checks, |
| | | | and perform |
| | | | mention routing. |
| TeamSettings.Read.Group | Channel | The autonomous | The autonomous |
| | | software agent | software agent |
| | | system 100 can | system 100 can |
| | | read team settings. | respect team-level |
| | | | policies and tailor |
| | | | behavior. |
| ChatMember.Read.Chat | Chat | The autonomous | The autonomous |
| | | software agent | software agent |
| | | system 100 can | system 100 can |
| | | read chat | address/respond |
| | | participants. | correctly and |
| | | | support audit trails. |
| ChatMessage.Read.Chat | Chat | The autonomous | The autonomous |
| | | software agent | software agent |
| | | system 100 can | system 100 can |
| | | read messages in | process prompts, |
| | | chats where a | context, and follow- |
| | | connected bot | up messages. |
| | | participates. | |
| ChatMessage.Send.Chat | Chat | The autonomous | The autonomous |
| | | software agent | software agent |
| | | system 100 can | system 100 |
| | | send messages in | responds to users in |
| | | 1:1 and group | direct messages and |
| | | chats where a | group chats, posts |
| | | connected bot | notifications, and |
| | | participates, not for | interactive replies |
| | | channels. | in chat threads. |
| ChatSettings.Read.Chat | Chat | The autonomous | The autonomous |
| | | software agent | software agent |
| | | system 100 can | system 100 can |
| | | read chat settings. | align behavior with |
| | | | chat policies (rate |
| | | | limits, who can |
| | | | post, etc.). |

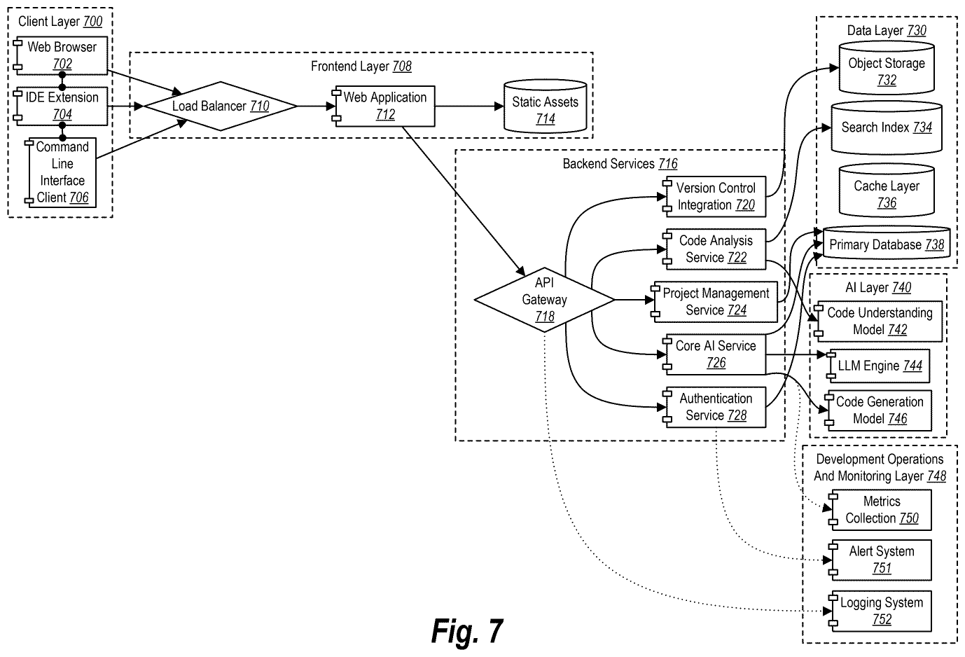

FIG. 7 illustrates architectural details of the autonomous software agent system 100 using one or more machine learning models in accordance with one or more embodiments. In particular, the autonomous software agent system 100 deploys an autonomous software agent with a plurality of computer software composition tools, generates one or more artificial intelligence outputs responsive to a software task, and provides responses to prompts submitted via an interface.

As shown in FIG. 7, the autonomous software agent system 100 contains a client layer 700 (e.g., with a web browser 702, an IDE extension 704, and a command line interface client 706), a frontend layer 708 with a load balancer 710 (e.g., which is a system to distribute incoming traffic across multiple servers which optimizes efficiency), a web application 712 (e.g., a Devin web application that shows a chat interface and the fully featured software composition tools of the autonomous software agent), and static assets 714 (e.g., files that do not dynamically change based on user interactions, such as HTML files, CSS files, JavaScript files, images, etc.).

Moreover, FIG. 7 shows the autonomous software agent system 100 also contains backend services 716 with an API gateway 718 (e.g., which is a single entry point for managing and routing API requests from client devices to different microservices/backend systems), a version control integration 720 (e.g., a backend service application to track changes to code such as a connected code repository application part of a code repository management system), a code analysis service 722, a project management service 724 (e.g., a software system to track the development of various tasks that a software development team is working on), a core AI service 726 (e.g., artificial intelligence modules or tools to handle the use of machine learning models, natural language processing, and other artificial intelligence tasks), and an authentication service 728 (e.g., to check for valid authentication credentials).

In particular, the backend services 716 include applications that all communicate with the backend web-server of the autonomous software agent system 100, which performs the job of deploying autonomous software agents, and orchestrating/managing sessions (Devin sessions), as well as providing the APIs to display data about the autonomous software agent system 100 on various computing devices, generating artificial intelligence outputs, orchestrating the execution of software tasks by accessing a plurality of software composition tools, and providing a plurality of interactive tools to a user computing device. In particular, the backend services 716 of the autonomous software agent system 100 manage the generation of artificial intelligence outputs for executing a software task of a development session.

For example, the backend services 716 perform the job of enabling request decomposition, artificial intelligence plan generation, terminal command generation, computer code generation, navigation actions, software task orchestration, and interactive tools of the autonomous software agent. In particular, the client layer 700, the frontend layer 708 and the backend services 716 are in consistent communication with one another to notify each service regarding any input received from a user computing device (e.g., via a chat interface and/or user intervention via interactive tools). Thus, this enables the autonomous software agent system 100 to immediately transfer that input/context to a deployed autonomous software agent.

Further, FIG. 7 shows a data layer 730 with object storage 732 (e.g., which is storage of unstructured data), a search index 734 (e.g., an index of one or more code repositories), a cache layer 736 (e.g., a layer that temporarily holds frequently accessed or recently computed data), and a primary database 738 (e.g., a central data store to hold application data). Moreover, FIG. 7 shows an AI layer 740 with a code understanding model 742, an LLM engine 744, and a code generation model 746. Moreover, FIG. 7 shows a development operations and monitoring layer 748 (e.g., with metrics collection 750, an alert system 751, and a logging system 752).

As shown in FIG. 7, the autonomous software agent system 100 utilizes the AI layer 740 to perform a variety of reasoning/generation tasks. In particular, the autonomous software agent system 100 accesses the AI layer 740 every time a code repository is connected or updated, or a new session is spun up (e.g., each time a new development box is activated). In order to enable the AI layer 740, the autonomous software agent system 100 provides various onboarding tools to a user computing device. In particular the onboarding tools allow a user to provide access to a code repository provider (e.g., a Gitprovider), select repositories, assign read access, and assign write access.

In some embodiments, the autonomous software agent system 100 prompts a user of a computing device for additional access permissions. In particular, the autonomous software agent system 100 can prompt the user for additional access permissions after generating a response to a prompt or during an autonomous software agent session. For example, the autonomous software agent system 100 determines during generating a response or executing software coding tasks that additional knowledge/permissions are needed to more thoroughly respond/perform a task.

As further shown in FIG. 7, the AI layer 740 of the autonomous software agent system 100 further includes the code understanding model 742. In particular, the code understanding model 742 analyzes computer code. In other words, the autonomous software agent system 100 seeks to understand the context and background of a code base/repository to generate an index of the code repository (e.g., to more effectively perform software coding tasks as a driver and not merely as a co-pilot).

In some embodiments, the autonomous software agent system 100 extracts contextual data from information provided by a user to generate an index using the code understanding model 742. To illustrate, the autonomous software agent system 100 parses through a code repository and generates abstraction summaries using the code understanding model 742 and one or more additional artificial intelligence models (e.g., such as the LLM engine).

Moreover, the autonomous software agent system 100 utilizes the AI layer 740 to enable AI-native features in a planner interface, a chat interface, or a configuration interface of an autonomous software agent. In particular, the autonomous software agent system 100 provides the AI-native features as options for a user computing device to activate during configuration or during interaction with the autonomous software agent system 100.

In some embodiments, the autonomous software agent system 100 uses the AI layer 740 to ingest data from a code base and further utilizes the code understanding model 742 to generate output predictions related to context of the code base. For example, the autonomous software agent system 100 connects to code repositories and creates knowledge inputs/suggestions based on processing the information in the code repository.

To illustrate, the autonomous software agent system 100 can read through documentation/specifications and then distills that information into data that is relevant for the code understanding model 742 of the autonomous software agent system 100. In addition, after generating the index of the code repository, the autonomous software agent system 100 further stores the index in the data layer 730 and/or uses the development operations and monitoring layer 748 to monitor changes/thresholds related to the connected code repository. This allows the autonomous software agent system 100 to more effectively execute software coding tasks when deploying an autonomous software agent.

Moreover, after generating the index of the code repository, the autonomous software agent system 100 further generates responses to prompts. In some embodiments, the autonomous software agent system 100 receives prompts from the frontend layer 708 submitted via an interface (or where the autonomous software agent system 100 intakes prompts, whether via the web application, a messaging application, or otherwise) and are sent to the backend services 716 of the autonomous software agent system 100, where the prompt is processed by the one or more artificial intelligence components (e.g., Devin's brain).

As shown in FIG. 7, the autonomous software agent system 100 utilizes the client layer 700 to receive interactions. In particular, users can submit a prompt of a question regarding a current development session, past development session, a code repository, etc. via a Devin messaging application integration, an application programming interface call, or directly through a web browser application of the intelligent search interface. In some embodiments, the messaging application integration lets users prompt the autonomous software agent system 100 and to further create sessions by tagging an autonomous software agent in their team's messaging server.

As just mentioned, the messaging application integration allows for development sessions to be created by tagging/mentioning an autonomous software agent. In some embodiments, the autonomous software agent system 100 receives a mention that tags the autonomous software agent to execute the software task (e.g., from a third-party messaging application between a plurality of users). Additionally, the autonomous software agent system 100 transmits the mention that tags the autonomous software agent to a virtual private cloud that hosts the independent virtual. This is shown in more detail below.

In some embodiments, as shown, the autonomous software agent system 100 utilizes the LLM engine 744 (e.g., a model that selects one or more large language models according to certain parameters/requirements) of an autonomous software agent to generate a response to a prompt. In particular, the autonomous software agent system 100 calls a first large language model for a first task (e.g., generating a first result for a prompt) and a second large language model for a second task (generating a second result for the prompt).

In one or more embodiments, the autonomous software agent system 100 utilizes the complex architectural design shown in FIG. 7. In particular, the autonomous software agent system 100 includes a natural language processing component (e.g., Devin's Brain) that allows the autonomous software agent system 100 to understand natural language descriptions (e.g., the functionalities of desired software programs). In some embodiments, the autonomous software agent system 100 utilizes natural language processing to analyze natural language descriptions in a prompt and to extract key functionalities and requirements.

In one or more embodiments, the autonomous software agent system 100 generates an index of a code repository (e.g., accessible by an autonomous software agent) as described in application Ser. No. 19/224,222 PROVIDING INTELLIGENT SEARCH FUNCTIONALITY OF A CODE REPOSITORY VIA AN AUTONOMOUS SOFTWARE AGENT which was filed on May 30, 2025, and is fully incorporated by reference herein.

As mentioned above, in some embodiments, the autonomous software agent system 100 generates a response to the prompt and uses the context from the response to deploy an autonomous software agent. In some embodiments, the autonomous software agent system 100 uses the autonomous software agent system 100 to spin up a development box, where each spun up development box contains knowledge and the autonomous software agent system from one session to another does not transfer the knowledge over to the next session. In some embodiments, knowledge allows the autonomous software agent system 100 to retrieve information based on specific triggers that might be relevant to the session. As also mentioned, this knowledge (depending on the trigger) is retrievable across all sessions.

As mentioned above, the autonomous software agent system 100 uses the autonomous software agent system 100 which deploys autonomous software agents that have access to their own machines. In particular, for each new spun up session, the autonomous software agent system 100 spins up a new development box (e.g., sandbox) which includes a fully featured IDE (shell, an editor, a browser, etc.). Moreover, the autonomous software agent system 100 allows a development box to be customized in a user's workspace (e.g., Devin's Workspace), where the user can save a specific machine snapshot that the autonomous software agent system 100 will use each time it spins up a new development box.

Furthermore, the autonomous software agent system generates development boxes that are isolated virtual machines. In particular, the development boxes run on top of a custom hypervisor implemented to support the virtual machine technology. Moreover, the state of a run (e.g., deploying an autonomous software agent) can be rolled-back to an earlier point in time. In rolling back to an earlier point in time, the autonomous software agent system 100 rolls back both the state of “Devin's brain” (e.g., the knowledge and the progress on a certain task), as well as the state of Devin's machine (e.g., the machine contents).

Moreover, in some embodiments, the autonomous software agent system 100 offers a virtual private cloud (VPC) deployment solution that allows development boxes to run within a customer's (a set of users) cloud tenant with the “Devin brain” (e.g., a component of the autonomous software agent) interacting with the development boxes over a secure tunnel. All data related to sessions are stored at rest in the customer cloud tenant.

Furthermore, each of these development boxes (or sessions) can speak to the customer-hosted services (connected via API integrations). Accordingly, the autonomous software agent system 100 can leverage the AI layer 740, the data layer 730, the backend services 716, and the frontend layer 708 to cause the graphical user interface on the user computing device to display the actions taken by the autonomous software agent (e.g., the actions via the software composition tools of the autonomous software agent).

Further, as already mentioned, the autonomous software agent system 100 includes machine learning models. In particular, the autonomous software agent system 100 utilizes pre-trained machine learning models to translate descriptions (e.g., from a response to a prompt) into artificial intelligence outputs (e.g., artificial intelligence plans, computer code, terminal commands, navigation actions, etc.). Moreover, the machine learning models utilized by the autonomous software agent system 100 have been trained on vast amounts of computer code data, which allows them to identify patterns and generate functional code. In some embodiments, the autonomous software agent system 100 utilizes the machine learning models to process the extracted information (e.g., key functionalities and requirements). In particular, the autonomous software agent system 100 utilizes the machine learning models to search for patterns and identify similar code structures from their training data.

Additionally, the autonomous software agent system 100 includes the code generation model 746. In particular, based on processed information from the natural language processing and the machine learning models, the autonomous software agent system 100 translates the descriptions into actual computer code. In other words, the output of the natural language processing and the machine learning model is pulled into the code generation engine to create viable computer code. In some embodiments, based on identified patterns, the autonomous software agent system 100 utilizes the code generation engine to create functional code responsive to deploying an autonomous software agent after generating a response to a prompt.

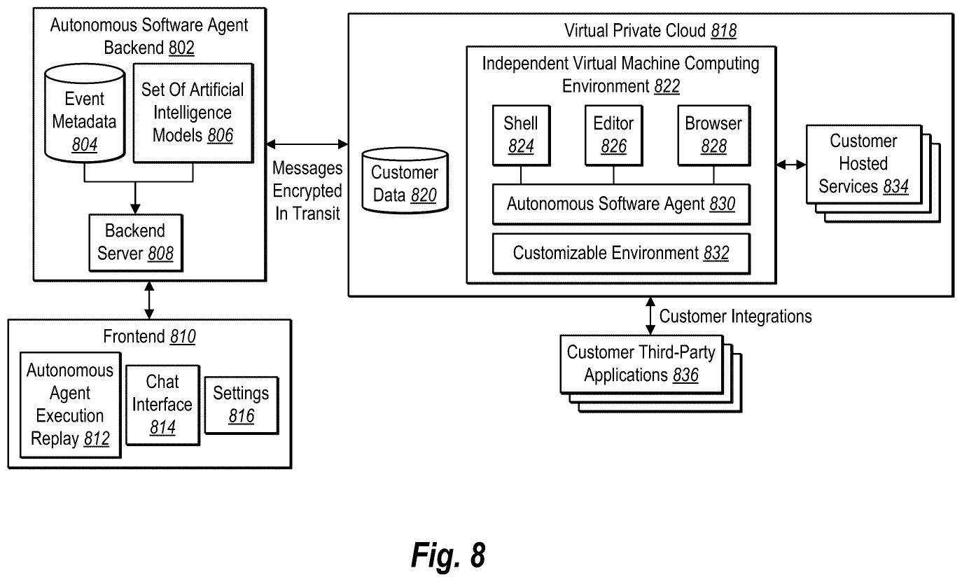

FIG. 8 illustrates additional details of the architecture of the autonomous software agent system 100 in accordance with one or more embodiments. For example, FIG. 8 shows that for each session of deploying an autonomous software agent, the autonomous software agent system 100 spins up/deploys an autonomous software agent backend 802 that includes a “backend container” paired with “a development box” virtual machine. In other words, the autonomous software agent system 100 initializes a development box (e.g., an independent virtual machine computing environment) with an autonomous software agent backend that includes a set of artificial intelligence models 806. As mentioned above, the set of artificial intelligence models 806 contains one or more machine learning/artificial intelligence models shown above used to process, analyze, and generate data.

As shown in FIG. 8, the autonomous software agent backend 802 includes event metadata 804 (e.g., context surrounding a prompt/request submitted to a web application interface, a response to the prompt, or other external sources that contain contextual data), the set of artificial intelligence models 806 (e.g., one or more machine learning models shown and discussed in FIG. 7), and a backend server 808 (e.g., a server that handles logic, database interactions, authentication, and other services for deploying an autonomous software agent).

Further, FIG. 8 shows the autonomous software agent backend 802 interacting with a frontend 810 which includes autonomous agent execution replay 812 (e.g., replay for a timelapse of a development session, a session replay that is a recording of previous user interactions with the autonomous software agent system 100), chat UI 814 (e.g., the graphical user interface provided to a user to submit prompts), and settings 816 (e.g., custom settings established by the autonomous software agent system 100 or by a user).

Moreover, the autonomous software agent backend 802 communicates with a virtual private cloud 818 (e.g., a customer virtual private cloud, which is a dedicated and isolated virtual network within a public cloud service) via encrypted messages. In particular, FIG. 8 shows an independent virtual machine computing environment 822 hosted on the virtual private cloud 818 and the virtual private cloud 818 further includes customer data 820.

Additionally, the independent virtual machine computing environment 822 further includes a shell 824, an editor 826 (e.g., integrated development environment), a browser 828, an autonomous software agent 830, a customizable environment 832 (e.g., playbooks, knowledge, etc. that customize an independent virtual machine computing environment) and customer hosted services 834 (e.g., services or applications hosted and managed by a tenant organization). Additionally, FIG. 8 shows that the virtual private cloud 818 can integrate various applications via access tokens/API keys. In particular, the autonomous software agent system can use the independent virtual machine computing environment 822 (e.g., the autonomous software agent) to write various code and make integrations with applications integrated with the virtual private cloud 818 (e.g., customer third-party applications 836).

In one or more embodiments, the autonomous software agent system 100 transmits a prompt that tags the autonomous software agent 830 (e.g., from the third-party messaging application) to the virtual private cloud 818 that hosts the independent virtual machine computing environment 822 for the autonomous software agent 830 to execute the software task. Furthermore, in some embodiments, the autonomous software agent system 100 executes the software task by transmitting encrypted communications between the virtual private cloud 818 that hosts the independent virtual machine computing environment 822 and the autonomous software agent backend 802 that includes the set of artificial intelligence models 806. Additionally, in some embodiments, the autonomous software agent system 100 generates, utilizing the set of artificial intelligence models 806, the artificial intelligence outputs and transmits the artificial intelligence outputs to a server of the messaging application for digital conversations between the plurality of users.

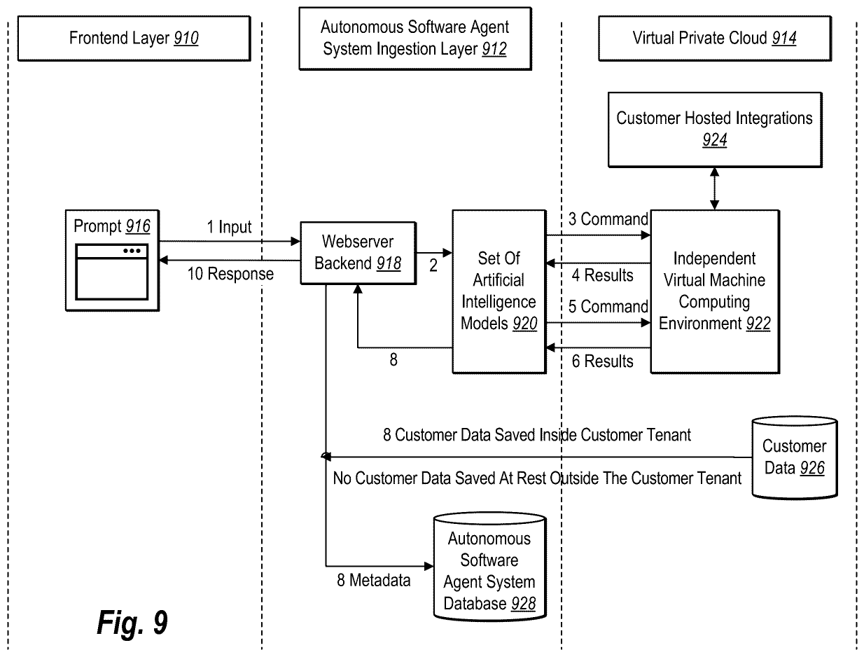

Further, FIG. 9 shows that the autonomous software agent system 100 receives a prompt 916 via a frontend layer 910. In response to the prompt 916, the autonomous software agent system 100 responds to the prompt 916 with a webserver backend 918 and further passes the information to a set of artificial intelligence models 920 (e.g., one or more artificial intelligence models shown above in FIG. 7) part of an autonomous software agent system ingestion layer 912.

As further shown in FIG. 9, the autonomous software agent system 100 passes commands/results back and forth between a virtual private cloud 914 (e.g., an independent virtual machine computing environment 922) and the set of artificial intelligence models 920. In other words, FIG. 9 illustrates the interaction between the frontend layer 910 of the autonomous software agent system 100, the autonomous software agent system ingestion layer 912 of the autonomous software agent system 100, and an autonomous software agent deployed for performing tasks at the virtual private cloud 914. Furthermore, the independent virtual machine computing environment 922 also accesses customer hosted integrations 924 at the virtual private cloud 914.

Additionally, FIG. 9 shows customer data 926 at the virtual private cloud 914 which the autonomous software agent system 100 passes all customer data saved inside the customer tenant to the tenant (e.g., and no customer data is saved at rest outside the customer tenant). Moreover, FIG. 9 shows the autonomous software agent system 100 using the webserver backend 918 to pass metadata to an autonomous software agent system database 928.

In one or more embodiments, the autonomous software agent system 100 receives an autonomous software agent prompt and deploys an autonomous software agent, which includes one or more machine learning components (e.g., large language models). In one or more embodiments, the autonomous software agent system 100 utilizes a text encoder to generate a set of text tokens for the autonomous software agent prompt.

Moreover, based on the text tokens, the autonomous software agent system 100 generates an artificial intelligence plan (e.g., breaks down the software task), and further reasons how to complete one or more tasks. In particular, the autonomous software agent system uses the independent virtual machine computing environment 922 to communicate with the set of artificial intelligence models 920 (e.g., the artificial intelligence components shown in FIG. 7) to determine which shell commands to make, computer code to write (e.g., in the editor), and webpages to browse.

In one or more embodiments, the autonomous software agent system 100 further utilizes a text encoder to process a prompt/request to deploy an autonomous software agent. In particular, the text encoder includes a component of a neural network to transform textual data (e.g., the text prompt) into a numerical representation. For instance, the autonomous software agent system 100 utilizes the text encoder to transform the prompt into a text encoding (e.g., text tokens). Further, the autonomous software agent system 100 utilizes the text encoder in a variety of ways.

For instance, the autonomous software agent system 100 utilizes the text encoder to i) determine the frequency of individual words in the text prompt (e.g., each word becomes a feature vector), ii) determine a weight for each word within the text prompt to generate a text vector that captures the importance of words within a text prompt, iii) generate low-dimensional text vectors in a continuous vector space that represents words within the text prompt, and/or iv) generate contextualized text vectors by determining semantic relationships between words within the text prompt.

Furthermore, although not shown in FIGS. 7-9, in one or more embodiments, the autonomous software agent system trains the set of artificial intelligence models 920 (e.g., artificial intelligence components such as the code generation engine, the natural language processing, and the machine learning models). For example, the autonomous software agent system 100 leverages a set of large language models and fine-tunes each large language model for different tasks. In particular, the autonomous software agent system 100 has a large language model for terminal requests, a large language model for generating computer code, a large language model for generating a plan, and a large language model for performing website browsing actions and determining a relevance of certain portions of a website domain page.

Moreover, the autonomous software agent system 100 trains the set of artificial intelligence models 920 by sending an input task to one or more of the large language models, generates a prediction for the input task, and compares the prediction with a ground truth reference. Based on the comparison, the autonomous software agent system 100 fine-tunes or modifies parameters of one or more large language models (e.g., that are part of the set of artificial intelligence models 920). Thus, at inference time, the autonomous software agent system 100 performs advanced reasoning tasks fine-tuned for specific use cases.

In addition, as alluded to above, the autonomous software agent system 100 trains machine learning models to translate descriptions into code. In some embodiments, the autonomous software agent system 100 trains multiple machine learning models for discrete tasks. In particular, the autonomous software agent system 100 trains a machine learning model to generate specific types of functional code. For example, the autonomous software agent system 100 utilizes a machine learning model to generate computer code from a description and compares the description to a ground truth reference and fine-tunes/modifies parameters of the machine learning model.

Moreover, the autonomous software agent system 100 further continuously learns from feedback and developer interactions. In particular, the autonomous software agent system 100 deploys autonomous software agents that perform a variety of tasks, and in response to prompts and/or feedback (e.g., user intervention), the autonomous software agent system 100 learns from the interactions to improve its capabilities. In other words, the autonomous software agent system 100 fine-tunes the artificial intelligence components in response to updates/feedback received from users.

FIGS. 8-9 describe various architectural details of the autonomous software agent system 100. In particular, the architectural components of the autonomous software agent system 100 enable an autonomous software agent to perform a variety of tasks. To illustrate, the autonomous software agent system 100 performs repetitive coding tasks such as generating boilerplate code, data validation routines, and unit tests.

Moreover, the autonomous software agent system 100 performs code reviews (e.g., one or more software developers examine code written by others to identify potential issues and provide feedback) and debugging such as analyzing code to identify potential bugs and suggesting fixes/improvements. Furthermore, the autonomous software agent system 100 performs deployment automation to automate a deployment process of software (e.g., streamlining the transition from development to production).

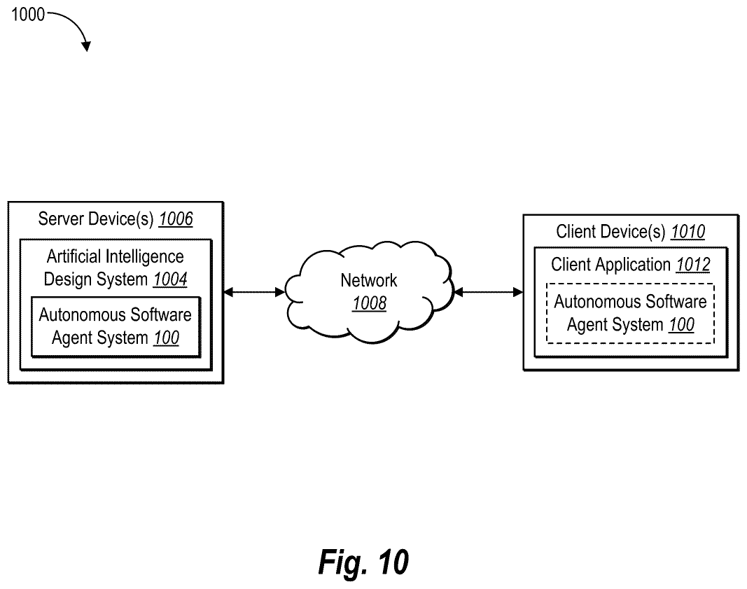

Additional details regarding the autonomous software agent system 100 will now be provided with reference to the figures. For example, FIG. 10 illustrates a schematic diagram of an exemplary system environment 1000 in which an autonomous software agent system 100 operates. As illustrated in FIG. 1, the system environment 1000 includes server device(s) 1006, an artificial intelligence system 1004, a network 1008, and client device(s) 1010. Additionally, FIG. 10 illustrates that the artificial intelligence system 1004 includes the autonomous software agent system 100.

Although the system environment 1000 of FIG. 10 is depicted as having a particular number of components, the system environment 1000 is capable of having a different number of additional or alternative components (e.g., a different number of servers, client devices, or other components in communication with the autonomous software agent system 100 via the network 1008). Similarly, although FIG. 10 illustrates a particular arrangement of the server device(s) 1006, the network 1008, and the client device(s) 1010, various additional arrangements are possible.

The server device(s) 1006, the network 1008, and the client device(s) 1010 are communicatively coupled with each other either directly or indirectly (e.g., through the network 1008 discussed in greater detail below). Moreover, the server device(s) 1006 and the client device(s) 1010 include one or more of a variety of computing devices (including one or more computing devices as discussed in greater detail below).

As mentioned above, the system environment 1000 includes the server device(s) 1006. In one or more embodiments, the server device(s) 1006 process input for a request (e.g., a request to configure an autonomous software agent or to deploy an autonomous software agent). In one or more embodiments, the server device(s) 1006 comprise a data server. In some implementations, the server device(s) 1006 comprise a communication server or a web-hosting server (e.g., for communications from a third-party messaging application). Furthermore, the server device(s) 1006 can be associated with the autonomous software agent system 100 or with an organization/company that deploys the autonomous software agent system 100.

In some embodiments, the client device(s) 1010 include computing devices associated with the one or more user accounts that submit requests for the autonomous software agent system 100. In some embodiments, the autonomous software agent system 100 trains one or more artificial intelligence models such as a code understanding model, one or more large language models, and a code generation model.

In one or more embodiments, the client device(s) 1010 include smartphones, tablets, desktop computers, laptop computers, head-mounted-display devices, or other electronic devices. The client device(s) 1010 include one or more software applications (e.g., the client application 1012) for generating content in accordance with the artificial intelligence system 1004. In one or more embodiments, the client application 1012 includes a software application hosted on the server device(s) 1006 accessible by the client device(s) 1010 through another application, such as a web browser.

To provide an example implementation, in some embodiments, the autonomous software agent system 100 on the server device(s) 1006 supports the autonomous software agent system 100 on the client device(s) 1010. For instance, in some cases, the artificial intelligence system 1004 on the server device(s) 1006 gathers data for the autonomous software agent system 100. In response, the autonomous software agent system 100, via the server device(s) 1006, provides the information to the client device(s) 1010. In other words, the client device(s) 1010 obtains (e.g., downloads) the autonomous software agent system 100 from the server device(s) 1006 that is already trained/optimized. Once downloaded, the autonomous software agent system 100 on the client device(s) 1010 is able to perform tasks (e.g., generative software tasks) independent from the server device(s) 1006. In one or more alternative implementations, the autonomous software agent system 100 generates or learns parameters for one or more artificial intelligence models (e.g., used to implement an autonomous software agent) in whole or in part on the client device(s) 1010.

In alternative implementations, the artificial intelligence system 1004 includes a web hosting application that allows the client device(s) 1010 to interact with content and services hosted on the server device(s) 1006. To illustrate, in one or more implementations, the client device(s) 1010 accesses a software application supported by the server device(s) 1006. In response, the artificial intelligence system 1004 on the server device(s) 1006 provides tools for monitoring/modifying/generating computer code using the autonomous software agent. In other words, the client device(s) 1010 does not have to download the autonomous software agent system 100 while still being able to access/utilize the trained/optimized tools provided by the artificial intelligence system 1004 via a web hosting application.

In some embodiments, the autonomous software agent system 100 is implemented in whole, or in part, by the individual elements of the system environment 1000. For instance, although FIG. 10 illustrates the autonomous software agent system 100 implemented or hosted on the server device(s) 1006, different components of the autonomous software agent system 100 are able to be implemented by a variety of devices within the system environment 1000. For example, one or more (or all) components of the autonomous software agent system 100 are implemented by a different computing device or a separate server from the server device(s) 1006. Indeed, as shown in FIG. 10, the client device(s) 1010 includes the autonomous software agent system 100.

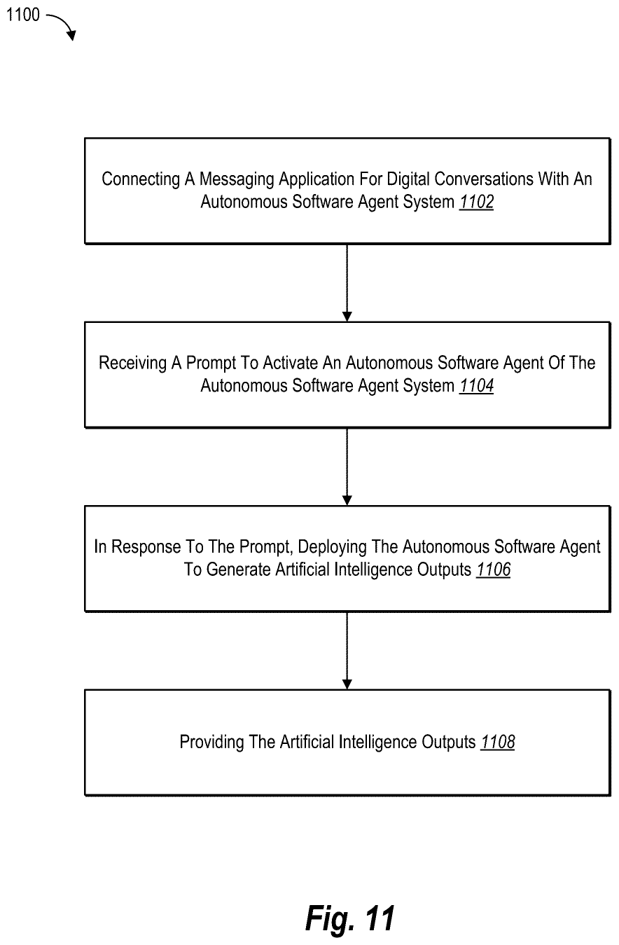

FIG. 11 illustrates a flowchart of a series of acts 1100 for connecting a messaging application with an autonomous software agent system in accordance with one or more embodiments. FIG. 11 illustrates acts according to one embodiment, alternative embodiments may omit, add to, reorder, and/or modify any of the acts shown in FIG. 11. In some implementations, the acts of FIG. 11 are performed as part of a method. For example, in some embodiments, the acts of FIG. 11 are performed as part of a computer-implemented method. Alternatively, a non-transitory computer-readable medium stores instructions thereon that, when executed by at least one processor, cause a computing device to perform the acts of FIG. 11. In some embodiments, a system performs the acts of FIG. 11. For example, in one or more embodiments, a system includes at least one memory device. The system further includes at least one server device configured to cause the system to perform the acts of FIG. 11.

The series of acts 1100 includes an act 1102 of connecting a messaging application for digital conversations with an autonomous software agent system. Further, the series of acts 1100 includes an act 1104 of receiving a prompt to activate an autonomous software agent of the autonomous software agent system. Moreover, the series of acts 1100 includes an act 1106 of in response to the prompt, deploying the autonomous software agent to generate artificial intelligence outputs. Additionally, the series of acts 1100 includes an act 1108 of providing the artificial intelligence outputs.

In particular, the act 1102 includes connecting a messaging application for digital conversations between a plurality of users with an autonomous software agent system. Further, the act 1104 includes receiving, from the messaging application, a prompt to activate an autonomous software agent of the autonomous software agent system to execute a software task. Moreover, the act 1106 includes in response to the prompt received from the messaging application, deploying the autonomous software agent that operates within an independent virtual machine computing environment to generate artificial intelligence outputs responsive to the prompt. Additionally, the act 1108 includes providing the artificial intelligence outputs to the messaging application. The series of acts 1100 further includes the below clauses.

Clause 1. A computer-implemented method comprising: connecting a messaging application for digital conversations between a plurality of users with an autonomous software agent system; receiving, from the messaging application, a prompt to activate an autonomous software agent of the autonomous software agent system to execute a software task; in response to the prompt received from the messaging application, deploying the autonomous software agent that operates within an independent virtual machine computing environment to generate artificial intelligence outputs responsive to the prompt; and providing the artificial intelligence outputs to the messaging application.

Clause 2. The computer-implemented method of clause 1, further comprising receiving, via the messaging application between the plurality of users, an additional prompt pertaining to the software task to modify the artificial intelligence outputs responsive to the prompt, wherein the additional prompt corresponds to a first user of the plurality of users.

Clause 3. The computer-implemented method of any of clauses 1-2, further comprising: generating, utilizing the autonomous software agent, additional artificial intelligence outputs responsive to the additional prompt; and providing the additional artificial intelligence outputs to the messaging application.

Clause 4. The computer-implemented method of any of clauses 1-3, further comprising: receiving, via the messaging application between the plurality of users, another prompt pertaining to the software task to modify the additional artificial intelligence outputs, wherein the another prompt corresponds to a second user of the plurality of users; and providing the another prompt to modify the additional artificial intelligence outputs to the messaging application.

Clause 5. The computer-implemented method of any of clauses 1-4, further comprising: providing artificial intelligence outputs responsive to different stages of executing the software task to a first conversation thread of the messaging application; and providing progress status updates to a second conversation thread of the messaging application.

Clause 6. The computer-implemented method of any of clauses 1-5, wherein providing the progress status updates further comprises: generating, utilizing the autonomous software agent to access a plurality of software composition tools, the artificial intelligence outputs, wherein the plurality of software composition tools comprise a shell tool, a browser tool, an integrated development environment, and a planner tool; and generating a first progress status update corresponding to the autonomous software agent utilizing the planner tool to decompose the prompt.

Clause 7. The computer-implemented method of any of clauses 1-6, wherein providing the progress status updates further comprises: generating a second progress status update corresponding to the autonomous software agent utilizing a shell tool to submit a terminal command; and providing an output corresponding to the terminal command to the first conversation thread of the messaging application.

Clause 8. The computer-implemented method of any of clauses 1-7, wherein providing the progress status updates further comprises: generating a third progress status update corresponding to the autonomous software agent utilizing an integrated development environment to write computer code; and providing an output corresponding to the computer code to the first conversation thread of the messaging application.

Clause 9. A system comprising: one or more memory devices; and one or more processors coupled to the one or more memory devices, configured to cause the system to: connect a messaging application for digital conversations between a plurality of users with an autonomous software agent system, wherein the messaging application comprises a plurality of conversation threads; receive, from the messaging application, a prompt tagging an autonomous software agent within a conversation thread to activate the autonomous software agent to execute a software task; in response to the prompt, deploy the autonomous software agent that operates within an independent virtual machine computing environment to generate artificial intelligence outputs responsive to the prompt; and provide progress status updates corresponding to the artificial intelligence outputs being responsive to different stages of executing the software task to the messaging application.

Clause 10. The system of clause 9, wherein the one or more processors are configured to cause the system to: transmit the prompt that tags the autonomous software agent to a virtual private cloud that hosts the independent virtual machine computing environment for the autonomous software agent to execute the software task; and execute the software task by transmitting encrypted communications between the virtual private cloud that hosts the independent virtual machine computing environment and an autonomous agent model backend comprising a set of large language models.

Clause 11. The system of any of clauses 9-10, wherein the one or more processors are configured to cause the system to: generate, utilizing the set of large language models, the artificial intelligence outputs; and transmit the artificial intelligence outputs to a server of the messaging application for digital conversations between the plurality of users.

Clause 12. The system of any of clauses 9-11, wherein the one or more processors are configured to cause the system to receive, from the messaging application, the prompt to execute the software task comprising a link to a code repository with text instructions to generate unit tests for the code repository.

Clause 13. The system of any of clauses 9-12, wherein the one or more processors are configured to cause the system to connect the messaging application with the autonomous software agent system by further: defining a plurality of keywords and functions for the messaging application to communicate with the autonomous software agent system, wherein the plurality of keywords and functions comprises defined text shortcuts to cause the autonomous software agent to perform specific types of tasks.

Clause 14. The system of any of clauses 9-13, wherein the one or more processors are configured to cause the system to: generate, utilizing the autonomous software agent to access a plurality of software composition tools, the artificial intelligence outputs, wherein the plurality of software composition tools comprise a shell tool, a browser tool, an integrated development environment, and a planner tool; and generate the progress status updates corresponding to the artificial intelligence outputs being responsive to different stages of executing the software task and the autonomous software agent accessing different software composition tools.

Clause 15. The system of any of clauses 9-14, wherein the one or more processors are configured to cause the system to: receive, from the messaging application between the plurality of users, an additional prompt pertaining to the software task to modify the artificial intelligence outputs responsive to the prompt, wherein the additional prompt corresponds to a first user of the plurality of users; and receive, from the messaging application between the plurality of users, another prompt that adds details to the additional prompt, wherein the another prompt corresponds to a second user of the plurality of users.

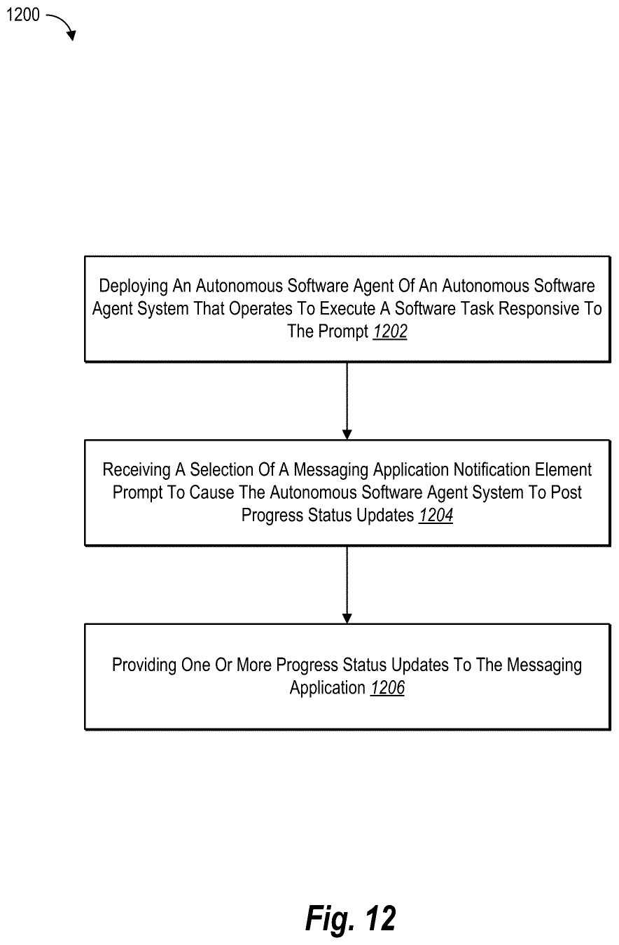

FIG. 12 illustrates a flowchart of a series of acts 1200 for providing progress status updates to a messaging application in accordance with one or more embodiments. FIG. 12 illustrates acts according to one embodiment, alternative embodiments may omit, add to, reorder, and/or modify any of the acts shown in FIG. 12. In some implementations, the acts of FIG. 12 are performed as part of a method. For example, in some embodiments, the acts of FIG. 12 are performed as part of a computer-implemented method. Alternatively, a non-transitory computer-readable medium stores instructions thereon that, when executed by at least one processor, cause a computing device to perform the acts of FIG. 12. In some embodiments, a system performs the acts of FIG. 12. For example, in one or more embodiments, a system includes at least one memory device. The system further includes at least one server device configured to cause the system to perform the acts of FIG. 12.

The series of acts 1200 includes an act 1202 of deploying an autonomous software agent of an autonomous software agent system that operates to execute a software task responsive to the prompt. Further, the series of acts 1200 includes an act 1204 of receiving a selection of a messaging application notification element prompt to cause the autonomous software agent system to post progress status updates. Moreover, the series of acts 1200 includes an act 1206 of providing one or more progress status updates to the messaging application.

In particular, the act 1202 includes in response to a prompt received via a graphical user interface of a web browser, deploying an autonomous software agent of an autonomous software agent system that operates to execute a software task responsive to the prompt. Further, the act 1204 includes receiving, from the graphical user interface of the web browser, a selection of a messaging application notification element prompt to cause the autonomous software agent system to post progress status updates pertaining to an execution of the software task within a messaging application between a plurality of users. Moreover, the act 1206 includes providing one or more progress status updates pertaining to the software task to the messaging application. The series of acts 1200 further includes the below clauses.

Clause 16. A non-transitory computer-readable medium storing executable instructions which, when executed by at least one processing device, cause the at least one processing device to perform operations comprising: in response to a prompt received via a graphical user interface of a web browser, deploying an autonomous software agent of an autonomous software agent system that operates to execute a software task responsive to the prompt; receiving, from the graphical user interface of the web browser, a selection of a messaging application notification element prompt to cause the autonomous software agent system to post progress status updates pertaining to an execution of the software task within a messaging application between a plurality of users; and providing one or more progress status updates pertaining to the software task to the messaging application.

Clause 17. The non-transitory computer-readable medium of clause 16, further comprising: generating, utilizing the autonomous software agent to access a plurality of software composition tools, artificial intelligence outputs from executing the software task; and generating the one or more progress status updates corresponding to the artificial intelligence outputs.

Clause 18. The non-transitory computer-readable medium of any of clauses 16-17, further comprising: receiving, from the messaging application between the plurality of users, an additional prompt pertaining to the software task to modify the artificial intelligence outputs responsive to the prompt, wherein the additional prompt corresponds to a first user of the plurality of users; and receiving, from the messaging application between the plurality of users, another prompt, wherein the another prompt corresponds to a second user of the plurality of users and comprise a file that includes contextual details for executing the additional prompt.

Clause 19. The non-transitory computer-readable medium of any of clauses 16-18, further comprising receiving, via the graphical user interface of the web browser to interact directly with an autonomous software agent system, additional files to execute the software task and a selection of an input to send the additional files to a conversation thread within the messaging application between the plurality of users.

Clause 20. The non-transitory computer-readable medium of any of clauses 16-19, further comprising: generating, utilizing a planner tool, an artificial intelligence plan by decomposing the prompt; generating a first progress status update corresponding to the artificial intelligence plan; and providing the artificial intelligence plan and a current step that the autonomous software agent is at within the artificial intelligence plan to the messaging application.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

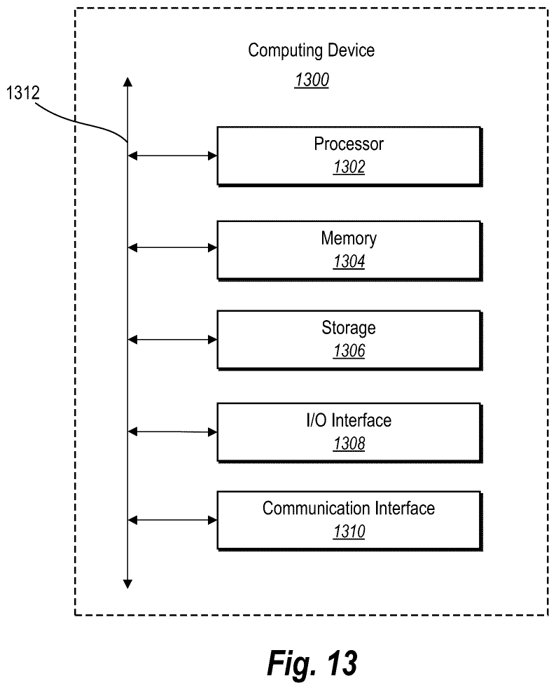

FIG. 13 illustrates a block diagram of an example computing device 1300 that may be configured to perform one or more of the processes described above. One will appreciate that one or more computing devices, such as the computing device 1300 may represent the computing devices described above (e.g., the server device(s) 1006 and/or the client device(s) 1010). In one or more embodiments, the computing device 1300 may be a mobile device (e.g., a mobile telephone, a smartphone, a PDA, a tablet, a laptop, a camera, a tracker, a watch, a wearable device). In some embodiments, the computing device 1300 may be a non-mobile device (e.g., a desktop computer or another type of client device). Further, the computing device 1300 may be a server device that includes cloud-based processing and storage capabilities.

As shown in FIG. 13, the computing device 1300 can include one or more processor(s) 1302, memory 1304, a storage device 1306, input/output interfaces 1308 (or “I/O interfaces 1308”), and a communication interface 1310, which may be communicatively coupled by way of a communication infrastructure (e.g., bus 1312). While the computing device 1300 is shown in FIG. 13, the components illustrated in FIG. 13 are not intended to be limiting. Additional or alternative components may be used in other embodiments. Furthermore, in certain embodiments, the computing device 1300 includes fewer components than those shown in FIG. 13. Components of the computing device 1300 shown in FIG. 13 will now be described in additional detail.

In particular embodiments, the processor(s) 1302 include hardware for executing instructions, such as those making up a computer program. As an example, and not by way of limitation, to execute instructions, the processor(s) 1302 may retrieve (or fetch) the instructions from an internal register, an internal cache, memory 1304, or a storage device 1306 and decode and execute them.

The computing device 1300 includes memory 1304, which is coupled to the processor(s) 1302. The memory 1304 may be used for storing data, metadata, and programs for execution by the processor(s). The memory 1304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1304 may be internal or distributed memory.

The computing device 1300 includes a storage device 1306 including storage for storing data or instructions. As an example, and not by way of limitation, the storage device 1306 can include a non-transitory storage medium described above. The storage device 1306 may include a hard disk drive (HDD), flash memory, a Universal Serial Bus (USB) drive or a combination these or other storage devices.

As shown, the computing device 1300 includes one or more I/O interfaces 1308, which are provided to allow a user to provide input to (such as user strokes), receive output from, and otherwise transfer data to and from the computing device 1300. These I/O interfaces 1308 may include a mouse, keypad or a keyboard, a touch screen, camera, optical scanner, network interface, modem, other known I/O devices or a combination of such I/O interfaces 1308. The touch screen may be activated with a stylus or a finger.

The I/O interfaces 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1308 are configured to provide graphical data to a display for presentation to a user. The graphical data may be representative of one or more graphical user interfaces and/or any other graphical content as may serve a particular implementation.

The computing device 1300 can further include a communication interface 1310. The communication interface 1310 can include hardware, software, or both. The communication interface 1310 provides one or more interfaces for communication (such as, for example, packet-based communication) between the computing device and one or more other computing devices or one or more networks. As an example, and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI. The computing device 1300 can further include a bus 1312. The bus 1312 can include hardware, software, or both that connects components of computing device 1300 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
connecting a messaging application for digital conversations between a plurality of users with an autonomous software agent system;
receiving, from the messaging application, a prompt to activate an autonomous software agent of the autonomous software agent system to execute a software task;
in response to the prompt received from the messaging application, deploying the autonomous software agent that operates within an independent virtual machine computing environment to generate artificial intelligence outputs responsive to the prompt; and
providing the artificial intelligence outputs to the messaging application.

2. The computer-implemented method of claim 1, further comprising receiving, via the messaging application between the plurality of users, an additional prompt pertaining to the software task to modify the artificial intelligence outputs responsive to the prompt, wherein the additional prompt corresponds to a first user of the plurality of users.

3. The computer-implemented method of claim 2, further comprising:
generating, utilizing the autonomous software agent, additional artificial intelligence outputs responsive to the additional prompt; and
providing the additional artificial intelligence outputs to the messaging application.

4. The computer-implemented method of claim 3, further comprising:
receiving, via the messaging application between the plurality of users, another prompt pertaining to the software task to modify the additional artificial intelligence outputs, wherein the another prompt corresponds to a second user of the plurality of users; and
providing the another prompt to modify the additional artificial intelligence outputs to the messaging application.

5. The computer-implemented method of claim 1, further comprising:
providing artificial intelligence outputs responsive to different stages of executing the software task to a first conversation thread of the messaging application; and
providing progress status updates to a second conversation thread of the messaging application.

6. The computer-implemented method of claim 5, wherein providing the progress status updates further comprises:
generating, utilizing the autonomous software agent to access a plurality of software composition tools, the artificial intelligence outputs,
wherein the plurality of software composition tools comprise a shell tool, a browser tool, an integrated development environment, and a planner tool; and
generating a first progress status update corresponding to the autonomous software agent utilizing the planner tool to decompose the prompt.

7. The computer-implemented method of claim 5, wherein providing the progress status updates further comprises:
generating a second progress status update corresponding to the autonomous software agent utilizing a shell tool to submit a terminal command; and
providing an output corresponding to the terminal command to the first conversation thread of the messaging application.

8. The computer-implemented method of claim 5, wherein providing the progress status updates further comprises:
generating a third progress status update corresponding to the autonomous software agent utilizing an integrated development environment to write computer code; and
providing an output corresponding to the computer code to the first conversation thread of the messaging application.

9. A system comprising:
one or more memory devices; and
one or more processors coupled to the one or more memory devices, configured to cause the system to:
connect a messaging application for digital conversations between a plurality of users with an autonomous software agent system, wherein the messaging application comprises a plurality of conversation threads;
receive, from the messaging application, a prompt tagging an autonomous software agent within a conversation thread to activate the autonomous software agent to execute a software task;
in response to the prompt, deploy the autonomous software agent that operates within an independent virtual machine computing environment to generate artificial intelligence outputs responsive to the prompt; and
provide progress status updates corresponding to the artificial intelligence outputs being responsive to different stages of executing the software task to the messaging application.

10. The system of claim 9, wherein the one or more processors are configured to cause the system to:
transmit the prompt that tags the autonomous software agent to a virtual private cloud that hosts the independent virtual machine computing environment for the autonomous software agent to execute the software task; and
execute the software task by transmitting encrypted communications between the virtual private cloud that hosts the independent virtual machine computing environment and an autonomous agent model backend comprising a set of large language models.

11. The system of claim 10, wherein the one or more processors are configured to cause the system to:
generate, utilizing the set of large language models, the artificial intelligence outputs; and
transmit the artificial intelligence outputs to a server of the messaging application for digital conversations between the plurality of users.

12. The system of claim 9, wherein the one or more processors are configured to cause the system to receive, from the messaging application, the prompt to execute the software task comprising a link to a code repository with text instructions to generate unit tests for the code repository.

13. The system of claim 9, wherein the one or more processors are configured to cause the system to connect the messaging application with the autonomous software agent system by further:
defining a plurality of keywords and functions for the messaging application to communicate with the autonomous software agent system,
wherein the plurality of keywords and functions comprises defined text shortcuts to cause the autonomous software agent to perform specific types of task.

14. The system of claim 9, wherein the one or more processors are configured to cause the system to:
generate, utilizing the autonomous software agent to access a plurality of software composition tools, the artificial intelligence outputs,
wherein the plurality of software composition tools comprise a shell tool, a browser tool, an integrated development environment, and a planner tool; and
generate the progress status updates corresponding to the artificial intelligence outputs being responsive to different stages of executing the software task and the autonomous software agent accessing different software composition tools.

15. The system of claim 9, wherein the one or more processors are configured to cause the system to:
receive, from the messaging application between the plurality of users, an additional prompt pertaining to the software task to modify the artificial intelligence outputs responsive to the prompt, wherein the additional prompt corresponds to a first user of the plurality of users; and
receive, from the messaging application between the plurality of users, another prompt that adds details to the additional prompt, wherein the another prompt corresponds to a second user of the plurality of users.

16. A non-transitory computer-readable medium storing executable instructions which, when executed by at least one processing device, cause the at least one processing device to perform operations comprising:
in response to a prompt received via a graphical user interface of a web browser, deploying an autonomous software agent of an autonomous software agent system that operates to execute a software task responsive to the prompt;
receiving, from the graphical user interface of the web browser, a selection of a messaging application notification element prompt to cause the autonomous software agent system to post progress status updates pertaining to an execution of the software task within a messaging application between a plurality of users; and
providing one or more progress status updates pertaining to the software task to the messaging application.

17. The non-transitory computer-readable medium of claim 16, further comprising:
generating, utilizing the autonomous software agent to access a plurality of software composition tools, artificial intelligence outputs from executing the software task; and
generating the one or more progress status updates corresponding to the artificial intelligence outputs.

18. The non-transitory computer-readable medium of claim 17, further comprising:
receiving, from the messaging application between the plurality of users, an additional prompt pertaining to the software task to modify the artificial intelligence outputs responsive to the prompt, wherein the additional prompt corresponds to a first user of the plurality of users; and
receiving, from the messaging application between the plurality of users, another prompt, wherein the another prompt corresponds to a second user of the plurality of users and comprise a file that includes contextual details for executing the additional prompt.

19. The non-transitory computer-readable medium of claim 18, further comprising receiving, via the graphical user interface of the web browser to interact directly with an autonomous software agent system, additional files to execute the software task and a selection of an input to send the additional files to a conversation thread within the messaging application between the plurality of users.

20. The non-transitory computer-readable medium of claim 16, further comprising:
generating, utilizing a planner tool, an artificial intelligence plan by decomposing the prompt;
generating a first progress status update corresponding to the artificial intelligence plan; and
providing the artificial intelligence plan and a current step that the autonomous software agent is at within the artificial intelligence plan to the messaging application.
